(19) United States
(12) Patent Application Publication
(10) Pub. No.: US 2011/0100897 A1
(43) Pub. Date: May 5, 2011

(54) SYSTEM AND METHOD FOR LIQUID PURIFICATION

(76) Inventor: Wesley Boerm, Mesa, AZ (US)

(21) Appl. No.: 12/914,848

(22) Filed: Oct. 28, 2010

Related U.S. Application Data
(60) Provisional application No. 61/256,886, filed on Oct. 30, 2009.

(51) Int. Cl. C02F 9/00; B01D 21/00

(52) U.S. Cl. 210/252

(57) ABSTRACT

A liquid purification system includes an upflow liquid purification system which receives a first flow of liquid. The upflow liquid purification system treats the liquid in response to the liquid flowing upwardly through the upflow liquid purification system. The liquid purification system includes a downflow liquid purification vessel which receives a first flow of liquid. The upflow liquid purification system treats the liquid in response to the liquid flowing upwardly through the upflow liquid purification system.

### CROSS-REFERENCE TO RELATED APPLICATIONS

This application claims priority to U.S. Provisional Application No. 61/256,886, filed on Oct. 30, 2009, the contents of which are incorporated by reference as though fully set forth herein.

### BACKGROUND OF THE INVENTION

1. Field of the Invention

This invention relates generally to liquid purification or separation processes.

2. Description of the Related Art

It is often necessary to purify a liquid to make it suitable for a desired purpose. For example, raw water is water taken from the environment, and is generally not considered safe for drinking or washing without purification. Raw water is a mixture of desired drinking water and undesired solid contaminants. Raw water is often purified in a water purification works to separate the undesired solid contaminants from the desired drinking water. The undesired solid contaminants are removed from the drinking water because it is unhealthy to ingest them. Examples of undesired solid contaminants include arsenic and iron, among others. Hence, purifying the liquid often involves receiving a liquid mixture, which includes a desired liquid portion and an undesired solid portion, and separating the undesired solid portion from the desired liquid portion.

The liquid mixture can be a non-homogeneous or homogeneous liquid mixture. An example of a non-homogeneous liquid mixture is a colloid, such as paint, which includes a solvent with a solute dispersed therein. The solvent and solute are immiscible when the solute remains in the form of a solid and does not form a solution with the solvent. The solute of an immiscible liquid mixture is often in the form of solid particles suspended in the solvent. The solid particles suspended in the solvent are sometimes referred to as floc particles. The solute does not form a solution with the solvent when the solute is not dissolved by the solvent.

A homogeneous liquid mixture is a liquid solution that includes a solute dissolved in a solvent. The liquid solution is miscible when the solvent dissolves the solute. An example of a solution is saltwater, wherein the solvent is water and the solute is salt. Another example of a solution is raw water, wherein the solvent is water and one type of solute is arsenic. It should be noted that some liquid mixtures include portions that are homogeneous and other portions that are non-homogeneous.

There are many different systems that operate to purify a liquid mixture, such as raw water. Examples of such systems can be found in U.S. Pat. Nos. 3,925,205, 4,199,451 and 6,428,705, as well as in International Application No. PCT/US2005/033064. However, it is desirable to provide a liquid purification system that is capable of providing purer water at a faster rate.

### BRIEF SUMMARY OF THE INVENTION

The present invention is directed to a system for purifying a liquid, as well as a method for manufacturing and using the system. The novel features of the invention are set forth with particularity in the appended claims. The invention will be best understood from the following description when read in conjunction with the accompanying drawings.

### BRIEF DESCRIPTION OF THE DRAWINGS

FIG. 1a is a side view of a liquid purification system.

FIG. 1b is a side view of one embodiment of liquid purification system of FIG. 1a.

FIGS. 2a and 2b are side and cut-away side views of upflow liquid purification systems of the liquid purification system of FIG. 1b.

FIGS. 3a and 3b are cut-away views of a region of FIG. 2b, wherein a lower input port is in fluid communication with a lower vessel portion.

FIGS. 3c and 3d are perspective and top views, respectively, of the lower input port of FIGS. 3a and 3b in fluid communication with the lower vessel portion.

FIGS. 4a and 4b are cut-away views of the region of FIG. 2b, wherein the lower input port is in fluid communication with the lower vessel portion.

FIGS. 4c and 4d are perspective and top views, respectively, of the lower input port of FIGS. 4a and 4b in fluid communication with the lower vessel portion.

FIGS. 5a and 5b are cut-away views of the region of FIG. 2b, wherein the lower input port is in fluid communication with the lower vessel portion.

FIGS. 5c and 5d are perspective and top views, respectively, of the lower input port of FIGS. 5a and 5b in fluid communication with the lower vessel portion.

FIGS. 6a and 6b are top and side views of one embodiment of a tube settler of FIG. 2b.

FIGS. 6c and 6d are top perspective and side views, respectively, of one embodiment of the tube settler of FIG. 2b with offset upper and lower channel openings.

FIGS. 6e and 6f are top perspective and side views, respectively, of one embodiment of the tube settler of FIG. 2b with offset upper and lower channel openings.

FIG. 6g is a perspective view of one embodiment of precipitation elements of buoyant precipitation media, as shown in FIG. 2b.

FIG. 6h is a perspective view of one embodiment of a baffle plate of FIG. 2b.

FIGS. 7a and 7b are side and cut-away side views of the downflow liquid purification system of FIG. 1b.

FIG. 8a is a perspective view of one embodiment of precipitation elements of buoyant precipitation media, as shown in FIG. 7b.

FIG. 8b is a perspective view of one embodiment of a baffle plate of FIG. 7b.

FIGS. 8c and 8d are top and side views of one embodiment of a tube settler of FIG. 7b.

FIGS. 8e and 8f are top perspective and side views, respectively, of one embodiment of the tube settler of FIGS. 8c and 8d with offset upper and lower channel openings.

FIGS. 8g and 8h are top perspective and side views, respectively, of one embodiment of the tube settler of FIGS. 8c and 8d with offset upper and lower channel openings.

FIG. 9a is a perspective view of a tube settler shroud.

FIGS. 9b and 9c are upper and lower perspective views of the tube settler shroud of FIG. 9a coupled to the tube settler of FIG. 7b.

FIG. 9d is a top view of the tube settler and tube settler shroud of FIGS. 9b and 9c.

FIG. 9e is another embodiment of an upflow channel.

FIG. 10 is another embodiment of a liquid purification system.

FIGS. 11a and 11b are other embodiments of liquid purification systems.

FIGS. 12a-12h are embodiments of lower vessel portions of an upflow liquid purification system.

FIGS. 13a-13f are embodiments of lower vessel portions of an upflow liquid purification system.

FIGS. 14a and 14b are embodiments of lower vessel portions of a downflow liquid purification system.

### DETAILED DESCRIPTION OF THE INVENTION

The invention involves a water purification system which purifies a liquid mixture, wherein the liquid mixture includes a solvent and solute. The water purification system purifies the liquid mixture by increasing and decreasing the concentration of the solvent and solute, respectively, of the liquid mixture to provide a purified liquid. Hence, the purified liquid has a larger concentration of the solvent and a smaller concentration of the solute than the liquid mixture.

In general, the liquid mixture is not suitable for a desired purpose, and the purified liquid is suitable for the desired purpose. In one example, the liquid mixture includes raw water, which is not suitable for drinking, and the purified liquid includes drinking water, which is suitable for drinking.

It should be noted that a portion of the solute of the liquid mixture is often dissolved with the solvent, and another portion of the solute of the liquid mixture is undissolved with the solvent. The portion of the undissolved solute forms solid particles, which are often referred to as floc particles.

The water purification system purifies the liquid mixture by increasing and decreasing the amount of undissolved and dissolved solute, respectively, of the liquid mixture. The water purification system purifies the liquid mixture by forming floc particles with the undissolved solute. The number of floc particles of the liquid mixture increases and decreases in response to increasing and decreasing, respectively, the amount of undissolved solute of the liquid mixture. The number of floc particles of the liquid mixture increases and decreases in response to decreasing and increasing, respectively, the amount of dissolved solute of the liquid mixture.

The water purification system purifies the liquid mixture by separating the floc particles from the liquid mixture. The number of floc particles of the liquid mixture decreases in response to separating the floc particles from the liquid mixture. The amount of undissolved solute of the liquid mixture decreases in response to increasing the number of floc particles separated from the liquid mixture.

In one embodiment, the water purification system includes upflow and downflow liquid purification systems in fluid communication with each other, wherein the upflow liquid purification system receives the liquid mixture and the downflow liquid purification system provides the purified liquid. The downflow liquid purification system provides the purified liquid in response to the upflow liquid purification system receiving the liquid mixture.

The upflow liquid purification system increases the purity of the received liquid mixture by increasing and decreasing the concentration of the solvent and solute, respectively, of the received liquid mixture to provide a purified liquid mixture. The purified liquid mixture is more pure than the received liquid mixture received because the concentration of the dissolved solute of the purified liquid mixture is less than that of the received liquid mixture. The upflow liquid purification system provides the purified liquid mixture in response to receiving the liquid mixture. The upflow liquid purification system provides the purified liquid mixture to the downflow liquid purification system, as will be discussed in more detail below.

The purity of the received liquid mixture is increased in response to the liquid mixture flowing upwardly through the upflow liquid purification system. Further, the purity of the received liquid mixture is increased in response to the floc particles flowing downwardly through the upflow liquid purification system.

The upflow liquid purification system purifies the received liquid mixture by increasing and decreasing the amount of undissolved and dissolved solute, respectively, of the received liquid mixture. The amount of undissolved and dissolved solute is increased and decreased, respectively, in response to the received liquid mixture flowing upwardly through the upflow liquid purification system.

The upflow liquid purification system purifies the received liquid mixture by forming floc particles with the undissolved solute. The number of floc particles of the received liquid mixture increases and decreases in response to increasing and decreasing, respectively, the amount of undissolved solute of the liquid mixture. The number of floc particles of the liquid mixture increases and decreases in response to decreasing and increasing, respectively, the amount of dissolved solute of the liquid mixture. The number of floc particles of the received liquid mixture is decreased and increased, respectively, in response to the received liquid mixture flowing upwardly through the upflow liquid purification system.

The upflow liquid purification system purifies the liquid mixture by separating the floc particles from the liquid mixture. The number of floc particles of the liquid mixture decreases in response to separating the floc particles from the liquid mixture. The amount of undissolved solute of the liquid mixture decreases in response to increasing the number of floc particles separated from the liquid mixture. In this way, the upflow liquid purification system coagulates and precipitates the fluid flowing therethrough.

The downflow liquid purification system increases the purity of the received purified liquid mixture by increasing and decreasing the concentration of the solvent and solute, respectively, of the purified liquid mixture to provide a purified liquid. The purity of the received purified liquid mixture is increased in response to the liquid mixture and floc particles flowing downwardly through the downflow liquid purification system. The downflow liquid purification system provides the purified liquid in response to receiving the purified liquid mixture.

The purified liquid is more pure than the purified liquid mixture received from the upflow liquid purification system because the concentration of the dissolved solute of the purified liquid is less than that of the purified liquid mixture. Further, the purified liquid is more pure than the liquid mixture received by the upflow liquid purification system because the concentration of the dissolved solute of the purified liquid is less than that of the liquid mixture.

The downflow liquid purification system purifies the purified liquid mixture by increasing and decreasing the amount of undissolved and dissolved solute, respectively, of the purified liquid mixture. The amount of undissolved and dissolved solute is increased and decreased, respectively, in response to the purified liquid mixture flowing downwardly through the downflow liquid purification system.

The downflow liquid purification system purifies the purified liquid mixture by forming floc particles with the undissolved solute. The number of floc particles of the purified liquid mixture increases and decreases in response to increasing and decreasing, respectively, the amount of undissolved solute of the liquid mixture. The concentration of dissolved solute of the purified liquid mixture decreases and increases decreases in response to increasing and decreasing, respectively, the number of floc particles of the purified liquid mixture. The number of floc particles of the purified liquid mixture is decreased and increased, respectively, in response to the purified liquid mixture flowing downwardly through the downflow liquid purification system.

The downflow liquid purification system purifies the purified liquid mixture by separating the floc particles from the purified liquid mixture. The number of floc particles of the purified liquid mixture decreases in response to separating the floc particles from the purified liquid mixture. The amount of dissolved solute of the purified liquid mixture decreases in response to increasing the number of floc particles separated from the liquid mixture. In this way, the downflow liquid purification system coagulates and precipitates the fluid flowing therethrough.

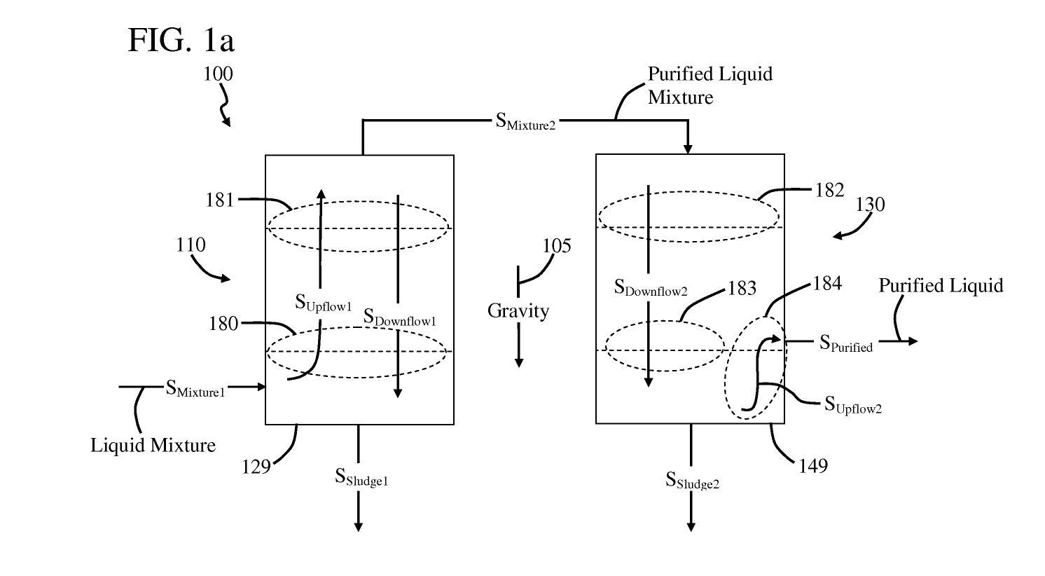

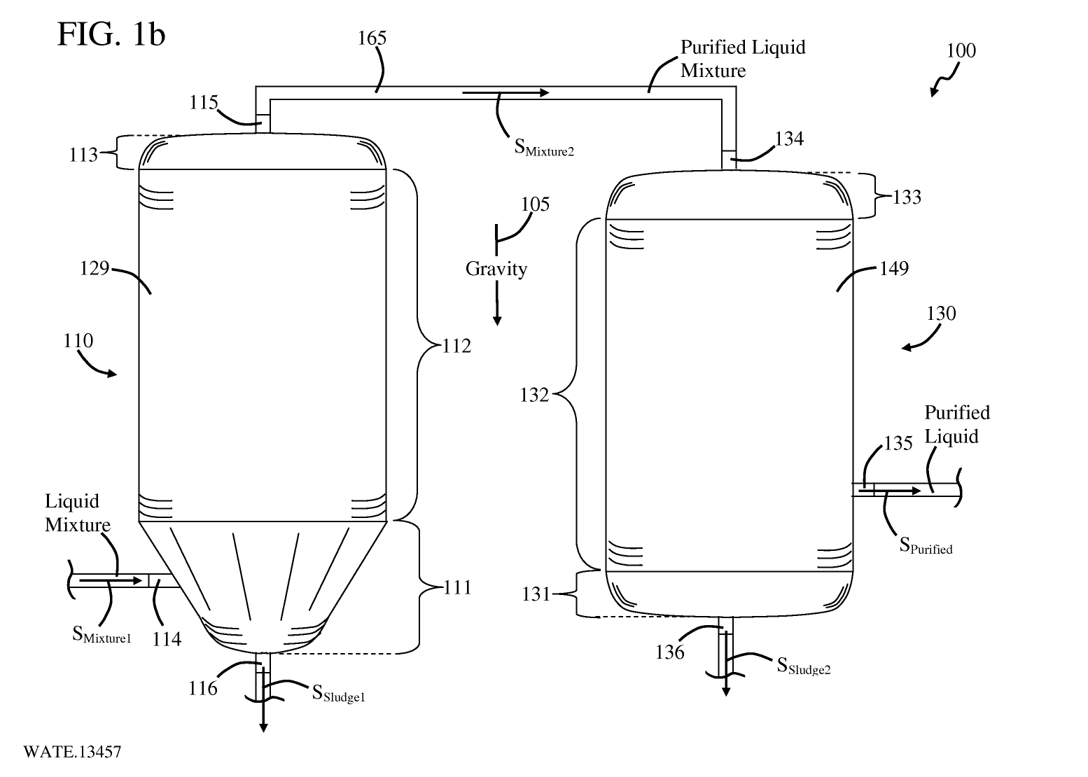

FIG. 1a is a side view of a liquid purification system 100. In this embodiment, liquid purification system 100 includes an upflow liquid purification system 110 having an upflow liquid purification vessel 129. Liquid purification vessel 129 receives a flow of a liquid mixture, denoted as S_{Mixture1}, wherein liquid mixture S_{Mixture1} includes a solvent and solute. Liquid mixture S_{Mixture1} can be a homogeneous or non-homogeneous liquid mixture. Further, liquid mixture S_{Mixture1} can be a liquid mixture that includes homogeneous and non-homogeneous portions.

As will be discussed in more detail below, liquid mixture S_{Mixture1} is purified in response to flowing upwardly through liquid purification vessel 129. The upflow of liquid mixture S_{Mixture1} is indicated by an arrow labeled S_{Upflow1} in FIG. 1a. Liquid mixture S_{Mixture1} is purified by separating the solute of S_{Mixture1} from the solvent of S_{Mixture1} to provide a purified liquid mixture, denoted as purified liquid mixture S_{Mixture2}. The solute of S_{Mixture1} is separated from the solvent of S_{Mixture1} by precipitating liquid mixture S_{Mixture1} to form floc particles of the solute. A portion of liquid mixture S_{Mixture1} is precipitated in an upflow precipitation region 181, which extends proximate to an upper portion of upflow liquid purification vessel 129. Precipitation region 181 is an upflow precipitation region because liquid mixture S_{Mixture1} is precipitated in response to flowing upwardly therethrough.

Purified liquid mixture S_{Mixture2} includes a composition of liquid mixture S_{Mixture1} having a higher concentration of the solvent and lower concentration of the solute. Purified liquid mixture S_{Mixture2} can be a homogeneous or non-homogeneous liquid mixture. Further, purified liquid mixture S_{Mixture2} can be a liquid mixture that includes homogeneous and non-homogeneous portions.

Liquid purification vessel 129 provides a downwardly flow of sludge, denoted as S_{Sludge1}, wherein sludge S_{Sludge1} includes the floc particles of the solute of liquid mixture S_{Mixture1}. Sludge S_{Sludge1} includes floc particles of the solute separated from the solvent of liquid mixture S_{Mixture1}. The downflow of sludge S_{Sludge1} is indicated by an arrow labeled S_{Downflow1} in FIG. 1a. The floc particles of sludge S_{Sludge1} are settled in an upflow settling region 180, which extends proximate to a lower portion of upflow liquid purification vessel 129. Settling region 180 is an upflow settling region because liquid mixture S_{Mixture1} flows upwardly therethrough.

Upflow liquid purification system 110 is an upflow liquid purification system for many different reasons. One reason upflow liquid purification system 110 is an upflow liquid purification system is because liquid mixture S_{Mixture1} is received at a lower portion of upflow liquid purification vessel 129 and purified liquid mixture S_{Mixture2} is provided from an upper portion of upflow liquid purification vessel 129.

Upflow liquid purification system 110 is an upflow liquid purification system because the flow of liquid mixture S_{Mixture1} through upflow liquid purification vessel 129 is upwardly in a direction opposed to gravity, which flows downwardly in a downward direction 105. In particular, upflow liquid purification system 110 is an upflow liquid purification vessel because the flow of liquid mixture S_{Mixture1} therethrough is in a direction opposed to downward direction 105. It should be noted that the flow of sludge S_{Sludge1} through upflow liquid purification vessel 129 is in downward direction 105. In this way, liquid mixture S_{Mixture1} and sludge S_{Sludge1} flow in opposed directions through upflow liquid purification vessel 129.

In this embodiment, liquid purification system 100 includes a downflow liquid purification system 130 having a downflow liquid purification vessel 149. Liquid purification vessel 149 receives the flow of purified liquid mixture S_{Mixture2} from upflow liquid purification system 110.

As will be discussed in more detail below, purified liquid mixture S_{Mixture2} is purified in response to flowing downwardly through liquid purification vessel 149. The downflow of liquid mixture S_{Mixture2} is indicated by an arrow labeled S_{Dowflow2} in FIG. 1a. Purified liquid mixture S_{Mixture2} is purified by separating the solute of S_{Mixture2} from the solvent of S_{Mixture2} to provide a purified liquid, denoted as purified liquid S_{Purified}. The solute of S_{Mixture2} is separated from the solvent of S_{Mixture2} by precipitating liquid mixture S_{Mixture2} to form floc particles of the solute. A portion of liquid mixture S_{Mixture2} is precipitated in a downflow precipitation region 182, which extends through an upper portion of downflow liquid purification vessel 149. Precipitation region 182 is a downflow precipitation region because liquid mixture S_{Mixture2} is precipitated in response to flowing downwardly therethrough.

Purified liquid S_{Purified} includes a composition of purified liquid mixture S_{Mixture2} having a higher concentration of the solvent and lower concentration of the solute. Purified liquid S_{Purified} flows upwardly, as indicated by an arrow labeled S_{Upflow2} in FIG. 1a, and out of liquid purification vessel 149 proximate to a lower portion of liquid purification vessel 149. Purified liquid S_{Purified} flows upwardly in the direction opposed to downward direction 105. Purified liquid S_{Purified} flows upwardly through an upflow channel region 184. Purified liquid S_{Purified} flows out of downflow liquid purification system 130 proximate to a lower portion of liquid purification vessel 149.

Liquid purification vessel 149 provides a flow of sludge, denoted as S_{Sludge2}, wherein sludge S_{Sludge2} includes floc particles of the solute of purified liquid mixture S_{Mixture2}. Sludge S_{Sludge2} includes floc particles of the solute separated from the solvent of purified liquid mixture S_{Mixture2}. Sludge S_{Sludge2} flows downwardly as indicated by the arrow labeled S_{Dowflow2} in FIG. 1a. The floc particles of sludge S_{Sludge2} are settled in downflow settling region 183, which extends through a lower portion of downflow liquid purification vessel 149. Settling region 183 is a downflow settling region because liquid mixture S_{Mixture2} flows downwardly therethrough.

Downflow liquid purification system 130 is a downflow liquid purification system for many different reasons. One reason downflow liquid purification system 130 is a downflow liquid purification system is because purified liquid mixture S_{Mixture2} is received at an upper portion of downflow liquid purification vessel 149 and purified liquid S_{Purified} is provided from the lower portion of downflow liquid purification vessel 149.

Downflow liquid purification system 130 is a downflow liquid purification system because the flow of purified liquid mixture S_{Mixture2} through downflow liquid purification vessel 149 is downwardly in the direction of gravity, which flows in downward direction 105. In particular, downflow liquid purification system 130 is a downflow liquid purification vessel because the flow of purified liquid mixture S_{Mixture2} therethrough is in downward direction 105. It should be noted that the flow of sludge S_{Sludge2} through downflow liquid purification vessel 149 is downwardly in direction 105. In this way, purified liquid mixture S_{Mixture2} and sludge S_{Sludge2} flow in the same directions through downflow liquid purification vessel 149.

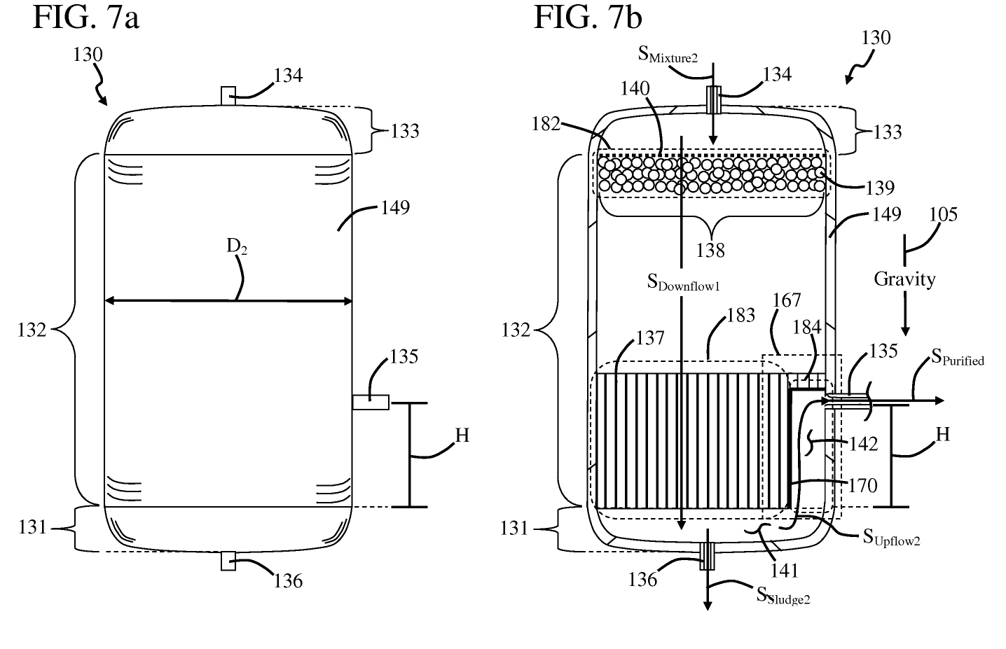

FIG. 1b is a side view of one embodiment of liquid purification system 100. In this embodiment, liquid purification system 100 includes upflow liquid purification system 110 and downflow liquid purification system 130, as discussed with FIG. 1a. Information regarding downflow liquid purification system 130 will be provided in more detail with the discussion of FIGS. 7a and 7b. Information regarding upflow liquid purification system 110 will be provided in more detail presently.

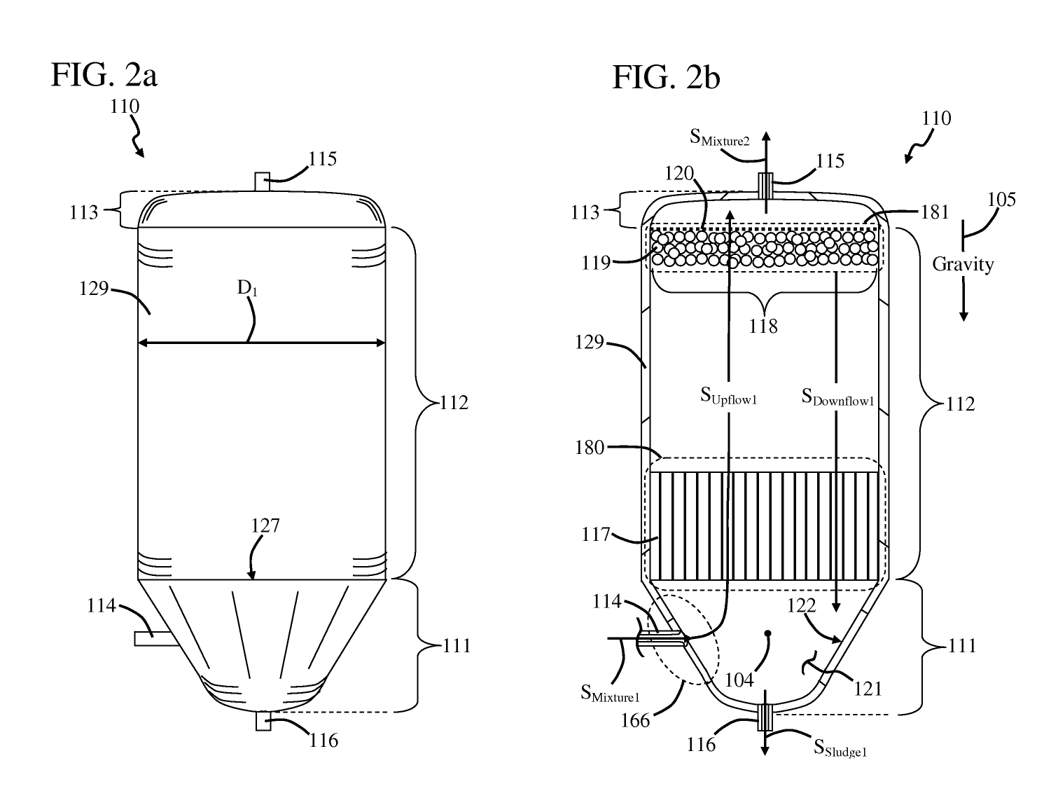

FIGS. 2a and 2b are side and cut-away side views of upflow liquid purification system 110. In this embodiment, upflow liquid purification system 110 includes upflow liquid purification vessel 129, and upflow liquid purification vessel 129 includes an intermediate vessel portion 112 with a lower vessel portion 111 and upper vessel portion 113 extending downwardly and upwardly therefrom, respectively. Intermediate vessel portion 112 has an outer dimension, which is denoted as dimension D₁ in FIG. 2a.

In this embodiment, liquid purification vessel 129 receives the flow of liquid mixture S_{Mixture1} at a lower input port 114. Lower output port 114 can be positioned at many different locations.

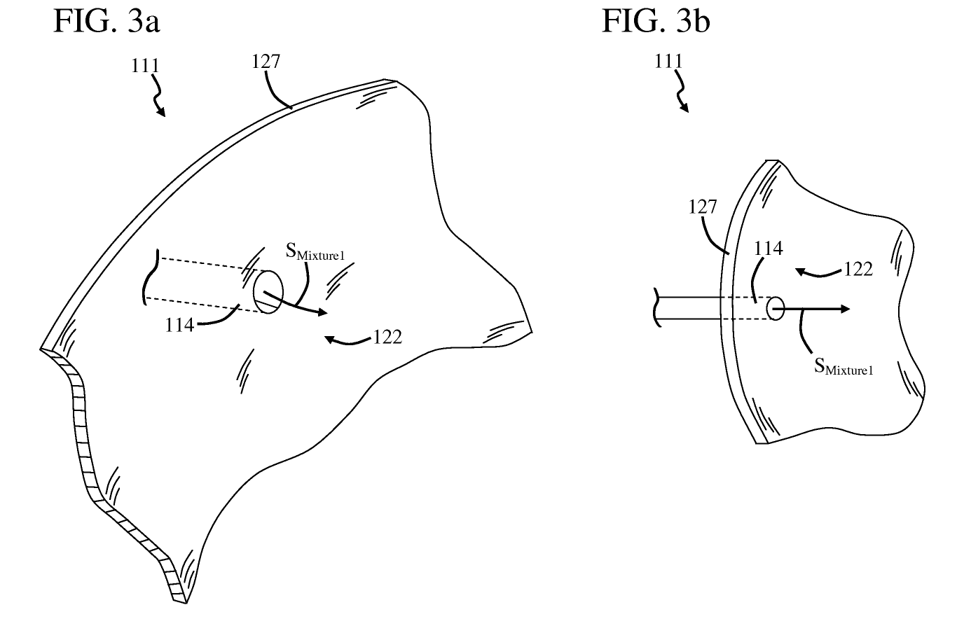

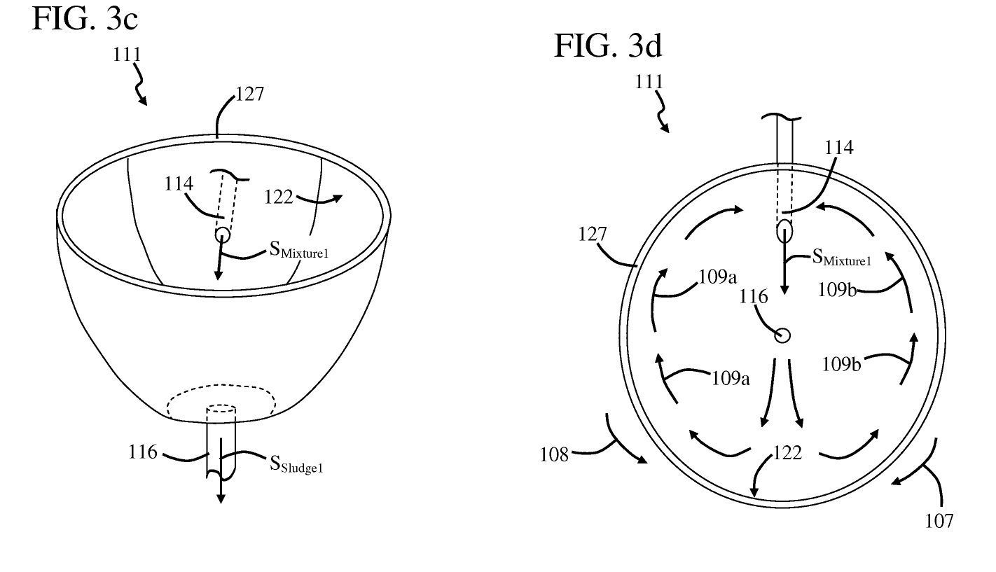

In this embodiment, lower output port 114 is positioned in fluid communication with lower vessel portion 111. Lower output port 114 can be positioned in fluid communication with lower vessel portion 111 in many different ways, several of which will be discussed below with FIGS. 3a-3d, FIGS. 4a-4d and FIGS. 5a-5d.

In this embodiment, liquid mixture S_{Mixture1} is purified in response to flowing upwardly through liquid purification vessel 129. The upflow of liquid mixture S_{Mixture1} is indicated by an arrow labeled S_{Upflow1} in FIG. 2b. Liquid mixture S_{Mixture1} is purified by separating the solute of S_{Mixture1} from the solvent of S_{Mixture1} to provide purified liquid mixture S_{Mixture2} at an output port 115. The solute of S_{Mixture1} is separated from the solvent of S_{Mixture1} by precipitating liquid mixture S_{Mixture1} to form floc particles of the solute. A portion of liquid mixture S_{Mixture1} is precipitated in upflow precipitation region 181, which extends proximate to upper vessel portion 113 of upflow liquid purification vessel 129. Precipitation region 181 is an upflow precipitation region because liquid mixture S_{Mixture1} is precipitated in response to flowing upwardly therethrough.

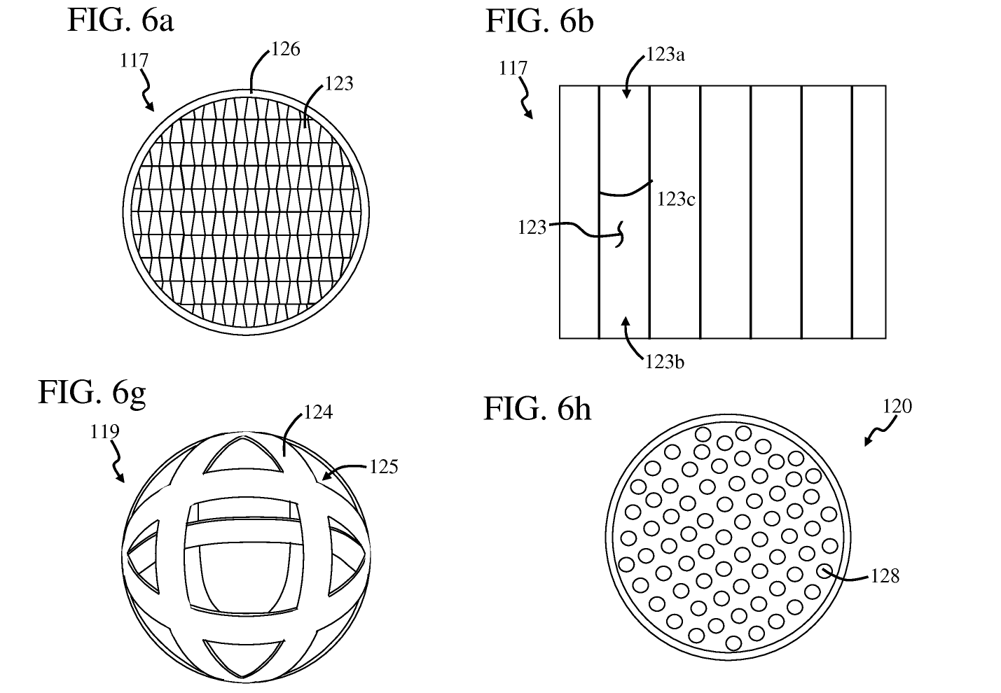

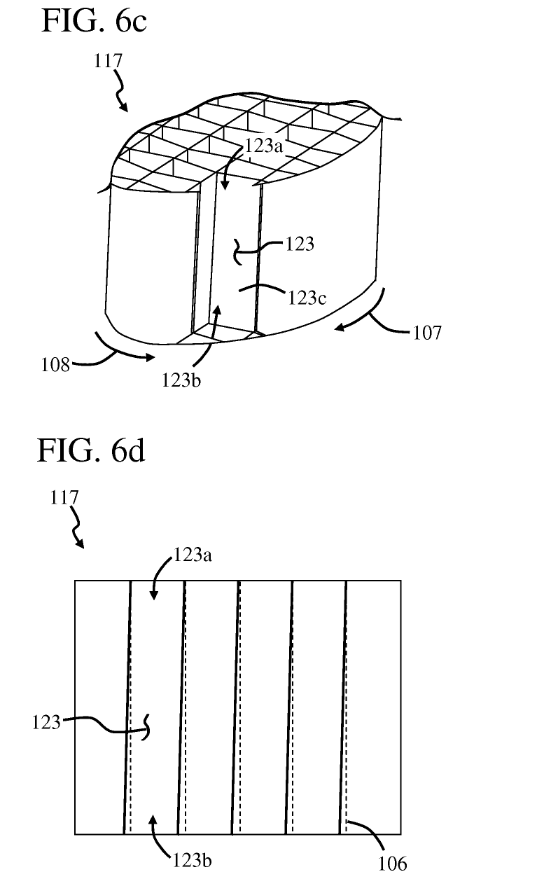

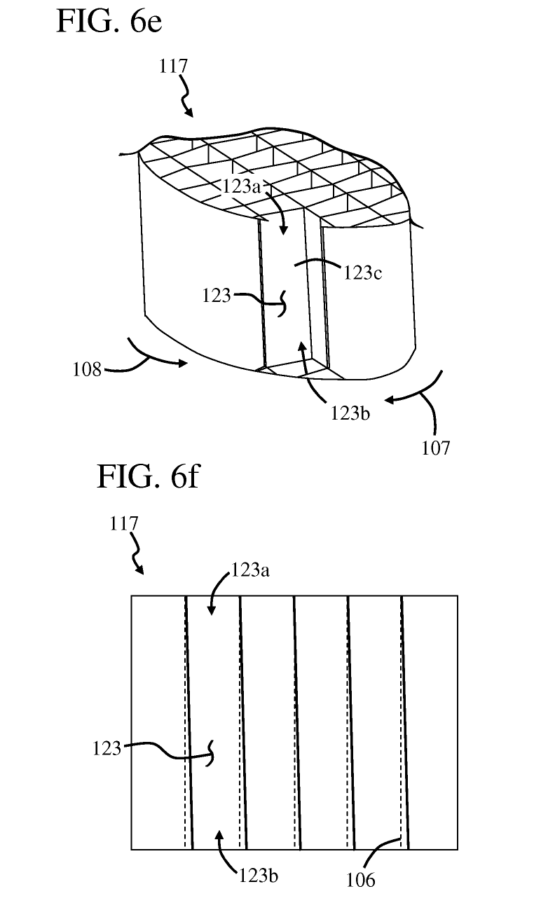

The portion of liquid mixture S_{Mixture1} can be precipitated in upflow precipitation region 181 in many different ways. In this embodiment, upflow precipitation region 181 includes a buoyant precipitation media 118 which includes a plurality of buoyant precipitation elements 119. More information regarding buoyant precipitation element 119 is discussed below with FIG. 6g.

In this embodiment, upflow liquid purification system 110 includes a baffle plate 120 positioned between buoyant precipitation region 118 and upper output port 115. More information regarding baffle plate 120 is discussed below with FIG. 6h. As will be discussed in more detail below, baffle plate 120 is positioned to restrict the ability of buoyant precipitation elements 119 to move between buoyant precipitation region 118 and upper output port 115.

Purified liquid mixture S_{Mixture2} includes a composition of liquid mixture S_{Mixture1} having a higher concentration of the solvent and lower concentration of the solute. Purified liquid mixture S_{Mixture2} can be a homogeneous or non-homogeneous liquid mixture. Further, purified liquid mixture S_{Mixture2} can be a liquid mixture that includes homogeneous and non-homogeneous portions.

Liquid purification vessel 129 provides a downwardly flow of sludge, denoted as S_{Sludge1}, wherein sludge S_{Sludge1} includes the floc particles of the solute of liquid mixture S_{Mixture1}. Sludge S_{Sludge1} includes floc particles of the solute separated from the solvent of liquid mixture S_{Mixture1}. The downflow of sludge S_{Sludge1} is indicated by an arrow labeled S_{Downflow1} in FIG. 2b. The floc particles of sludge S_{Sludge1} are settled in an upflow settling region 180, which extends through a lower portion of upflow liquid purification vessel 129. Settling region 180 is an upflow settling region because liquid mixture S_{Mixture1} flows upwardly therethrough. The floc particles of sludge S_{Sludge1} can be settled in upflow settling region 180 in many different ways.

In this embodiment, upflow settling region 180 includes a tube settler 117. More information regarding tube settler 117 is discussed below with FIGS. 6a-6f. A tube settler increases the settling capacity of a solute by reducing the distance a floc particle must settle before agglomerating to form a larger particle.

Upflow liquid purification system 110 is an upflow liquid purification system for many different reasons. One reason upflow liquid purification system 110 is an upflow liquid purification system is because liquid mixture S_{Mixture1} is received at a lower portion of upflow liquid purification vessel 129 and purified liquid mixture S_{Mixture2} is provided from an upper portion of upflow liquid purification vessel 129.

Upflow liquid purification system 110 is an upflow liquid purification system because the flow of liquid mixture S_{Mixture1} through upflow liquid purification vessel 129 is upwardly in a direction opposed to gravity, which flows downwardly in a downward direction 105. In particular, upflow liquid purification system 110 is an upflow liquid purification vessel because the flow of liquid mixture S_{Mixture1} therethrough is in a direction opposed to downward direction 105. It should be noted that the flow of sludge S_{Sludge1} through upflow liquid purification vessel 129 is in downward direction 105. In this way, liquid mixture S_{Mixture1} and sludge S_{Sludge1} flow in opposed directions through upflow liquid purification vessel 129.

FIGS. 3a and 3b are cut-away views of a region 166 of FIG. 2b, wherein lower input port 114 is in fluid communication with lower vessel portion 111. FIGS. 3c and 3d are perspective and top views, respectively, of lower input port 114 in fluid communication with lower vessel portion 111 as shown in FIGS. 3a and 3b.

In this embodiment, lower input port 114 extends perpendicular to conical chamber sidewall 122 of lower vessel portion 111. In particular, lower input port 114 extends perpendicular to conical chamber sidewall 122 of lower vessel portion 111 so that liquid mixture S_{Mixture1} flows through lower input port 114 towards a center portion 104 of lower vessel portion 111. Center portion 104 of lower vessel portion 111 is indicated in FIG. 2b, and is positioned above sludge output port 116.

As can be seen in FIG. 3d, liquid mixture S_{Mixture1} flows across lower vessel portion 111, wherein it engages conical chamber sidewall 122 at a location opposed to lower input port 114. A first portion 109a of liquid mixture S_{Mixture1} flows in a clockwise direction 107 in response to liquid mixture S_{Mixture1} engaging conical chamber sidewall 122 at the location opposed to lower input port 114. Further, a second portion 109b of liquid mixture S_{Mixture1} flows in a counter-clockwise direction 108 in response to liquid mixture S_{Mixture1} engaging conical chamber sidewall 122 at the location opposed to lower input port 114.

The clockwise and counter-clockwise flow of liquid mixture S_{Mixture1} through lower vessel portion 111 undesirably restricts the ability of liquid mixture S_{Mixture} to flow upwardly through tube settler 117. The flow of liquid mixture S_{Mixture} through lower vessel portion 111 is more turbulent because first and second portions 109a and 109b flow in directions 107 and 108, respectively. The ability of liquid mixture S_{Mixture} to flow upwardly through tube settler 117 is restricted in response to the turbulence of the flow of liquid mixture S_{Mixture} being increased. It is desirable to decrease the amount of turbulence experienced by liquid mixture in response to flowing through lower vessel portion 111. The amount of turbulence experienced by liquid mixture S_{Mixture} in response to flowing through lower vessel portion 111 can be decreased in many different ways, one of which will be discussed in more detail presently.

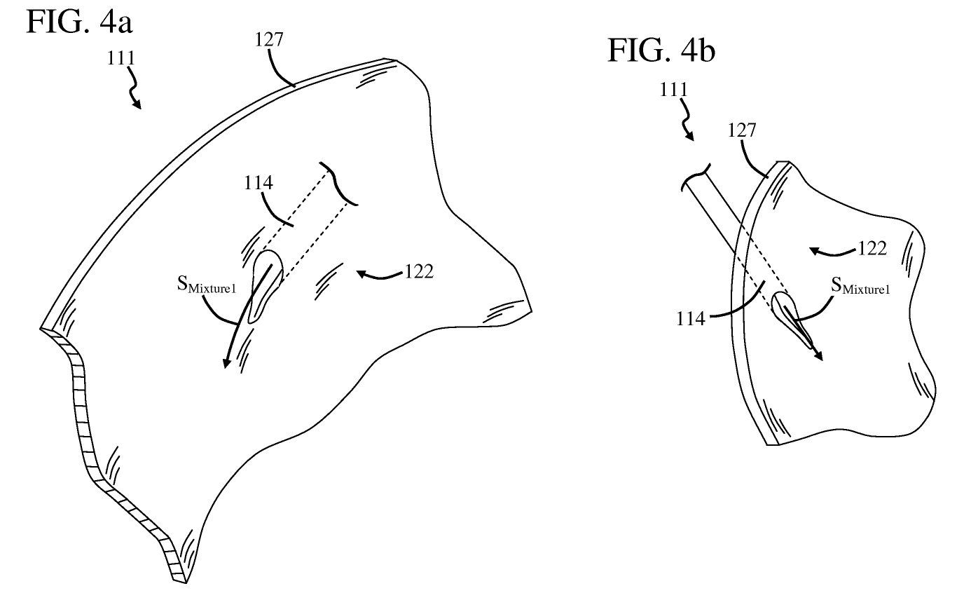

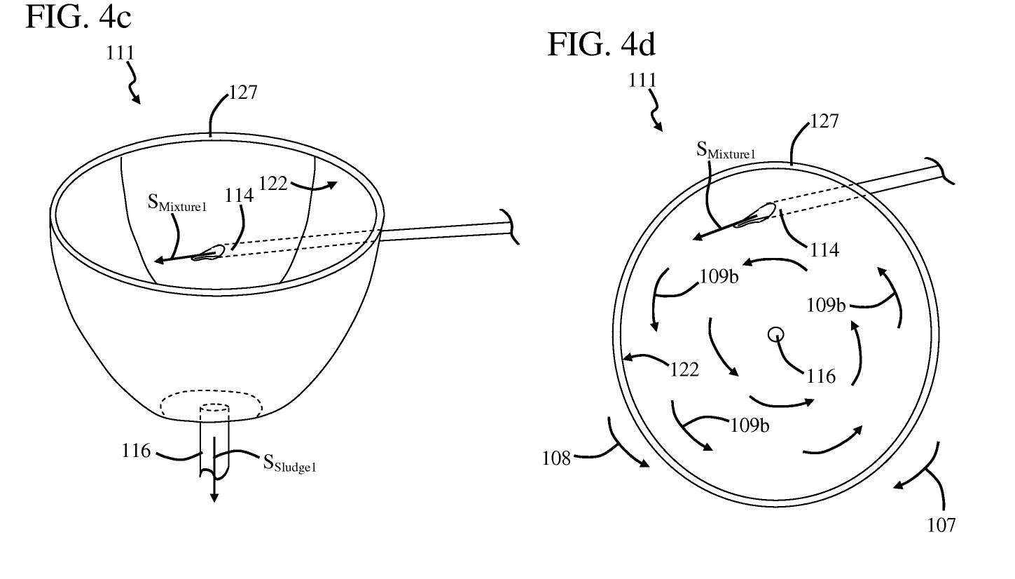

FIGS. 4a and 4b are cut-away views of region 166 of FIG. 2b, wherein lower input port 114 is in fluid communication with lower vessel portion 111. FIGS. 4c and 4d are perspective and top views, respectively, of lower input port 114 in fluid communication with lower vessel portion 111 as shown in FIGS. 4a and 4b. In this embodiment, lower input port 114 extends at a non-perpendicular angle relative to conical chamber sidewall 122 of lower vessel portion 111. In particular, lower input port 114 extends at a non-perpendicular angle relative to conical chamber sidewall 122 of lower vessel portion 111 so that liquid mixture S_{Mixture} flows along conical chamber sidewall 122 in counter-clockwise direction 108. Second portion 109b of liquid mixture S_{Mixture} flows in counter-clockwise direction 108 in response to liquid mixture S_{Mixture} engaging conical chamber sidewall 122 at a location proximate to lower input port 114. The amount of first portion 109a of liquid mixture S_{Mixture} is driven to zero because lower input port 114 extends at the angle relative to conical chamber sidewall 122 so that liquid mixture S_{Mixture} flows along conical chamber sidewall 122 in counter-clockwise direction 108. In this way, liquid mixture S_{Mixture} does not engage conical chamber sidewall 122 at a location opposed to lower input port 114 in response to flowing across lower vessel portion 111, as described in more detail above with FIGS. 3a-3d.

In the embodiment of FIGS. 4a-4d, the flow of liquid mixture S_{Mixture} through lower vessel portion 111 is less turbulent because second portion 109b flows in counter-clockwise direction 108, and the amount of first portion 109a flowing in clockwise direction 107 is driven to zero. In this way, the clockwise flow of first portion 109a through lower vessel portion 111 does not undesirably restrict the ability of second portion 109b to flow upwardly through tube settler 117.

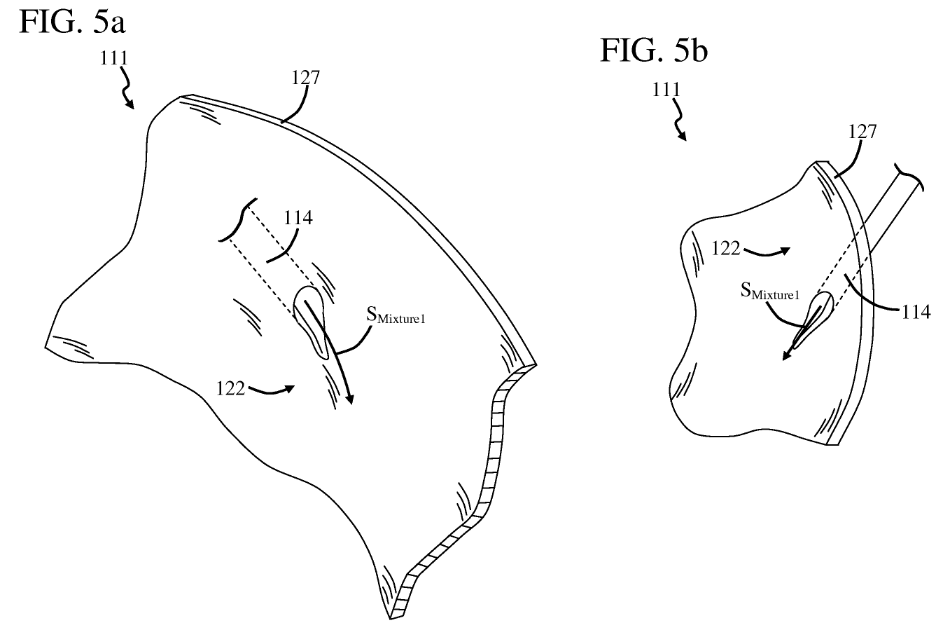

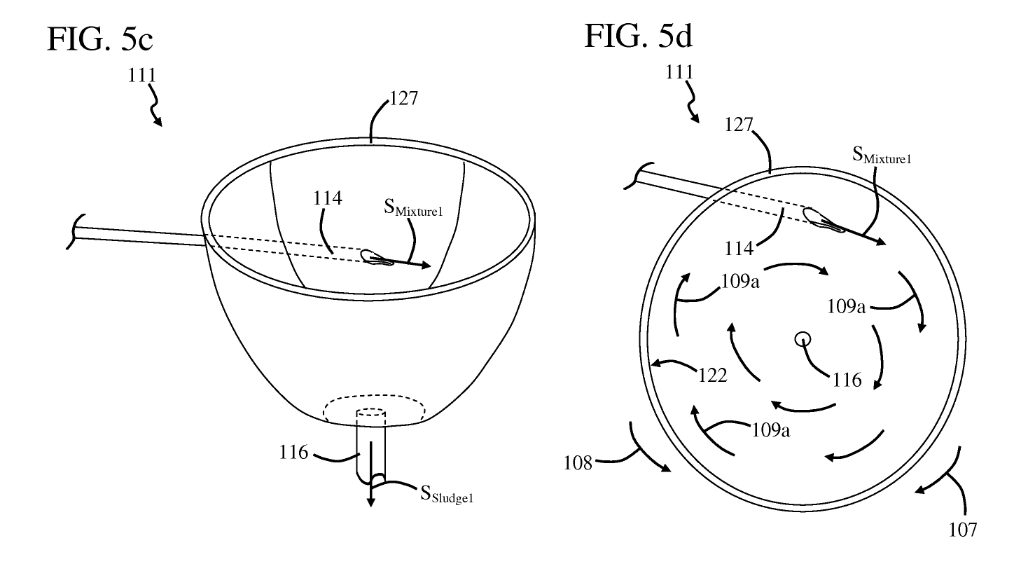

FIGS. 5a and 5b are cut-away views of region 166 of FIG. 2b, wherein lower input port 114 is in fluid communication with lower vessel portion 111. FIGS. 5c and 5d are perspective and top views, respectively, of lower input port 114 in fluid communication with lower vessel portion 111 as shown in FIGS. 5a and 5b.

In this embodiment, lower input port 114 extends at an angle relative to conical chamber sidewall 122 of lower vessel portion 111. In particular, lower input port 114 extends at an angle relative to conical chamber sidewall 122 of lower vessel portion 111 so that liquid mixture S_{Mixture} flows along conical chamber sidewall 122 in clockwise direction 107. First portion 109a of liquid mixture S_{Mixture1} flows in clockwise direction 107 in response to liquid mixture S_{Mixture} engaging conical chamber sidewall 122 at a location proximate to lower input port 114. The amount of second portion 109b of liquid mixture is driven to zero because lower input port 114 extends at an angle relative to conical chamber sidewall 122 so that liquid mixture flows along conical chamber sidewall 122 in clockwise direction 107. In this way, liquid mixture does not engage conical chamber sidewall 122 at a location opposed to lower input port 114 in response to flowing across lower vessel portion 111, as described in more detail above with FIGS. 3a-3d.

In the embodiment of FIGS. 4a-4d, the flow of liquid mixture S_{Mixture} through lower vessel portion 111 is less turbulent because first portion 109a flows in clockwise direction 107, and the amount of second portion 109b flowing in counter-clockwise direction 108 is driven to zero. In this way, the counter clockwise flow of second portion 109b through lower vessel portion 111 does not undesirably restrict the ability of first portion 109a to flow upwardly through tube settler 117.

FIGS. 6a and 6b are top and side views of one embodiment of tube settler 117. As mentioned above with the discussion of FIGS. 2a and 2b, the floc particles of sludge S_{Sludge1} are settled in upflow settling region 180, which includes tube settler 117. More information regarding tube settlers can be found in U.S. Pat. Nos. 3,925,205 and 5,384,178, as well as U.S. Design Pat. No. D255,153. Tube settlers are manufactured by Brentwood Industries, Inc. of Reading, Pa. It should be noted that tube settlers often receive a liquid that is trickled onto them. However, in this embodiment, the tube settlers of liquid purification system 100 are submerged during operation of liquid purification system 100.

Tube settler 117 increases the settling capacity of a solute of liquid mixture S_{Mixture1} by reducing the distance a floc particle must settle before agglomerating to form a larger particle. Tube settler 117 captures the floc particles of liquid mixture that move upwardly from conical chamber 121, and allows the larger floc particles to travel towards sludge output port 116.

In this embodiment, tube settler 117 includes a tube settler frame 126, which extends around its outer periphery. The shapes of tube settler 117 and tube setter frame 126 are chosen so that they can be positioned in upflow liquid purification vessel 129, as shown in FIG. 2b, and held in upflow settling region 180. It is desirable for tube settler frame 126 to engage the inner periphery of upflow liquid purification vessel 129 to increase the likelihood that liquid mixture S_{Upflow1} flows upwardly through tube settler 117. It should be noted that tube settler 117 is positioned above lower input port 114 and below upper output port 115.

In this embodiment, tube settler 117 includes a plurality of channels extending therethrough, wherein one channel is denoted as tube settler channel 123. Tube settler channel 123 collects the floc particles of liquid mixture S_{Mixture1}, and facilitates their ability to move downwardly towards sludge output port 116. Tube settler channel 123 includes upper channel opening 123a and lower channel opening 123b, wherein tube settler channel openings 123a and 123b are positioned away from and towards lower vessel portion 111, respectively. It should be noted that channel openings 123a and 123b are positioned above lower input port 114, and below upper output port 115. It should also be noted that tube settler channel 123 of the embodiment of tube settler 117 of FIGS. 6a and 6b extends parallel to direction 105, as shown in FIGS. 1a and 2b.

It should also be noted that liquid mixture S_{Mixture1} flows upwardly through the plurality of tube settler channels of tube settler 117. For example, a portion of liquid mixture S_{Mixture1} flows upwardly through tube settler channel 123. In particular, a portion of liquid mixture S_{Mixture1} flows upwardly through channel 123 from lower channel opening 123b to upper channel opening 123a. The portion of liquid mixture S_{Mixture1} flowing through channel 123 flows from lower channel opening 123b to upper channel opening 123a because, as mentioned above, lower channel opening 123b is positioned towards lower vessel portion 111 and upper channel opening 123a is positioned away from lower vessel portion 111, and lower input port 114 is positioned below lower channel opening 123b.

In this embodiment, channel openings 123a and 123b are aligned with each other because channel 123 extends vertically so that upper channel opening 123a is positioned above lower channel opening 123b. In other embodiments, however, channel 123 does not extend vertically so that channel openings 123a and 123b are offset from each other. Examples of offset upper and lower channel openings will be discussed in more detail presently.

FIGS. 6c and 6d are top perspective and side views, respectively, of one embodiment of tube settler 117 with offset upper and lower channel openings. It should be noted that portions of tube settler channel openings 123a and 123b overlap in a vertical direction. However, a different portion of tube settler channel opening 123b is positioned clockwise relative to tube settler channel 123a. In this way, tube settler channel openings 123a and 123b are offset from each other. It should be noted that the vertical direction is indicated by a reference line 106. In this embodiment, reference line 106 is parallel to downward direction 105, which is discussed in more detail above with FIGS. 1a and 1b. Hence, in this embodiment, tube settler channel openings 123a and 123b are offset from each other so that tube settler channel 123 does not extend parallel to direction 105.

As mentioned above, tube settler channel 123 collects the floc particles of liquid mixture S_{Mixture1} and facilitates their ability to move downwardly towards sludge output port 116. In general, tube settler 117 includes a plurality of channels 123 which extend at a non-parallel angle relative to downward direction 105. The non-parallel angle between channels 123 and downward direction 105 is chosen to provide an effective settling area. In general, the effective settling area increases and decreases in response to increasing and decreasing, respectively, the angle between channels 123 and downward direction 105. In some embodiments, the angle between channels 123 and downward direction 105 is in a range between about 30° to about 70°. In some embodiments, the angle between channels 123 and downward direction 105 is in a range between about 45° to about 60°. In one particular embodiment, the angle between channels 123 and downward direction 105 is about 60°.

In this embodiment, tube settler channel opening 123b is offset relative to tube settler channel opening 123a so that tube settler channel opening 123b is positioned clockwise relative to tube settler channel 123a. Tube settler channel opening 123b is positioned clockwise relative to tube settler channel opening 123a so that liquid mixture S_{Mixture1} flows upwardly in counter-clockwise direction 108 through channel 123. Further, tube settler channel opening 123b is positioned clockwise relative to tube settler channel opening 123a so that the floc particles of sludge S_{Sludge1} are more likely to settle on a sidewall 123c of tube settler 117, wherein sidewall 123c extends along tube settler channel 123 between upper tube settler channel opening 123a and lower tube settler channel opening 123b. In this way, the floc particles of sludge S_{Sludge1} are more likely to agglomerate to form larger floc particles. In general, the size of the floc particles increases and decreases as the offset between upper and lower channel openings increases and decreases, respectively.

It should be noted that it is useful to connect lower input port 114 to lower vessel portion 111 so that liquid mixture S_{Mixture1} flows in counter-clockwise direction 108 when tube settler 117 of FIGS. 6c and 6d is included with upflow liquid purification system 110. One way to connect lower input port 114 to lower vessel portion 111 so that liquid mixture S_{Mixture1} flows in counter-clockwise direction 108 is disclosed in FIGS. 4a-4d.

It is desirable to increase the size of the floc particles so they are more likely to flow with the downflow of sludge, which is indicated as S_{Downflow1} in FIGS. 1a and 2b. Floc particles that are more likely to flow with the downflow of sludge are more likely to flow through sludge output port 116.

Further, it is desirable to increase the size of the floc particles so they are less likely to flow with the upflow of liquid mixture, which is indicated as S_{Upflow1} in FIGS. 1a and 2b. Floc particles that are less likely to flow with the upflow of liquid mixture are less to flow through upper output port 115.

FIGS. 6e and 6f are top perspective and side views, respectively, of one embodiment of tube settler 117 with offset upper and lower channel openings. It should be noted that portions of tube settler channel openings 123a and 123b overlap in a vertical direction. However, a different portion of tube settler channel opening 123b is positioned clockwise relative to tube settler channel 123a. In this way, tube settler channel openings 123a and 123b are offset from each other. It should be noted that the vertical direction is indicated by reference line 106. In this embodiment, reference line 106 is parallel to direction 105, which is discussed in more detail above with FIGS. 1a and 1b. Hence, in this embodiment, tube settler channel openings 123a and 123b are offset from each other so that tube settler channel 123 does not extend parallel to direction 105.

In this embodiment, tube settler channel opening 123b is offset relative to tube settler channel opening 123a so that tube settler channel opening 123b is positioned counter-clockwise relative to tube settler channel 123a. Tube settler channel opening 123b is positioned counter-clockwise relative to tube settler channel opening 123a so that liquid mixture S_{Mixture1} flows upwardly in clockwise direction 107 through channel 123. Further, tube settler channel opening 123b is positioned counter-clockwise relative to tube settler channel opening 123a so that the floc particles of sludge S_{Sludge1} are more likely to settle on sidewall 123c of tube settler 117, wherein sidewall 123c extends along tube settler channel 123 between upper tube settler channel opening 123a and lower tube settler channel opening 123b. In this way, the floc particles of sludge S_{Sludge1} are more likely to agglomerate to form larger floc particles. As mentioned above, the size of the floc particles increases and decreases as the offset between upper and lower channel openings increases and decreases, respectively.

It should be noted that it is useful to connect lower input port 114 to lower vessel portion 111 so that liquid mixture S_{Mixture1} flows in clockwise direction 107 when tube settler 117 of FIGS. 6e and 6f is included with upflow liquid purification system 110. One way to connect lower input port 114 to lower vessel portion 111 so that liquid mixture S_{Mixture1} flows in clockwise direction 107 is disclosed in FIGS. 5a-5d.

As mentioned above, it is desirable to increase the size of the floc particles so they are more likely to flow with the downflow of sludge, which is indicated as S_{Downflow1} in FIGS. 1a and 2b. Floc particles that are more likely to flow with the downflow of sludge are more likely to flow through sludge output port 116.

Further, it is desirable to increase the size of the floc particles so they are less likely to flow with the upflow of liquid mixture, which is indicated as S_{Upflow1} in FIGS. 1a and 2b. Floc particles that are less likely to flow with the upflow of liquid mixture are less to flow through upper output port 115.

FIG. 6g is a perspective view of one embodiment of precipitation element 119 of buoyant precipitation media 118, as shown in FIG. 2b. More information regarding precipitation elements can be found in U.S. Pat. Nos. 4,200,532 and 6,811,147 and 7,014,175. In this embodiment, precipitation element 119 is spherical in shape and includes precipitation element ribs 124 and precipitation element openings 125. Precipitation element openings 125 facilitate the ability of liquid mixture S_{Upflow1} to flow through upflow precipitation region 181. In particular, precipitation element openings 125 facilitate the ability of liquid mixture S_{Upflow1} to flow through upflow precipitation region 181 and between lower input port 114 and upper output port 115.

Precipitation element ribs 124 facilitate the ability of floc particles to be separated from liquid mixture S_{Upflow1}. Precipitation element ribs 124 facilitate the ability of floc particles to be separated from liquid mixture S_{Upflow1} because ribs 124 increase the surface area of precipitation element 119. In general, the amount of floc particles separated from liquid mixture S_{Upflow1} increases and decreases as the surface area of precipitation element 119 increases and decreases, respectively.

It should be noted that the precipitation elements of buoyant precipitation media 118 are submerged during operation of liquid purification system 100. Further, the precipitation elements of buoyant precipitation media 118 include a buoyant material so that they are biased to float. The precipitation elements of buoyant precipitation media 118 are biased to float because they are biased to move in a direction opposed to direction 105 of FIGS. 1a and 1b when submerged. However, as mentioned above, it is desirable to include the precipitation elements in upflow precipitation region 181. Hence, it is desirable to restrict the ability of the precipitation elements to move upwardly away from upflow precipitation region 181 and towards upper output port 115. The ability of the precipitation elements to move upwardly away from upflow precipitation region 181 and towards upper output port 115 can be restricted in many different ways, one of which will be discussed in more detail presently.

FIG. 6h is a perspective view of one embodiment of baffle plate 120. In this embodiment, baffle plate 120 includes a plurality of baffle plate openings 128. Baffle plate openings 128 are sized to allow liquid mixture S_{Upflow1} to flow therethrough. In particular, baffle plate openings 128 are sized to allow liquid mixture S_{Upflow1} to flow through upflow precipitation region 181 and between lower input port 114 and upper output port 115.

However, baffle plate openings 128 are sized to restrict the ability of the precipitation elements of buoyant precipitation media 118 to move upwardly away from upflow precipitation region 181 and towards upper output port 115. Baffle plate openings 128 are sized to restrict the ability of the precipitation elements of buoyant precipitation media 118 to move upwardly away from upflow precipitation region 181 and towards upper output port 115 because the size of baffle plate openings 128 is less than the size of the precipitation elements of buoyant precipitation media 118. In this way, the precipitation elements of precipitation media 118 are held in upflow precipitation region 181.

As mentioned above with FIG. 2b, baffle plate 120 is positioned between buoyant precipitation region 118 and upper output port 115. Hence, the precipitation elements of buoyant precipitation media 118 engage baffle plate 120 in response to being submerged because they are buoyant and biased to float.

FIGS. 7a and 7b are side and cut-away side views of downflow liquid purification system 130. In this embodiment, downflow liquid purification system 130 includes downflow liquid purification vessel 149, and downflow liquid purification vessel 149 includes an intermediate vessel portion 132 with a lower vessel portion 131 and upper vessel portion 133 extending downwardly and upwardly therefrom, respectively.

In this embodiment, downflow liquid purification vessel 149 receives the flow of liquid mixture S_{Mixture2} at an upper input port 134. Downflow liquid purification vessel 149 receives the flow of liquid mixture S_{Mixture2} at upper input port 134 because upper input port 134 is in fluid communication with upper output port 115 through a fluid conduit 165, as shown in FIG. 1b. Upper input port 134 can be positioned at many different locations. In this embodiment, upper input port 134 is positioned in fluid communication with upper vessel portion 133.

In this embodiment, liquid mixture S_{Mixture2} is purified in response to flowing downwardly through downflow liquid purification vessel 149. The downflow of liquid mixture S_{Mixture2} is indicated by an arrow labeled S_{Downflow1} in FIG. 7b. Liquid mixture S_{Mixture2} is purified by separating the solute of S_{Mixture2} from the solvent of S_{Mixture2} to provide purified liquid mixture S_{Purified} at an intermediate output port 135. The solute of S_{Mixture2} is separated from the solvent of S_{Mixture2} by precipitating liquid mixture S_{Mixture2} to form floc particles of the solute. A portion of liquid mixture S_{Mixture2} is precipitated in downflow precipitation region 182, which extends proximate to upper vessel portion 133 of downflow liquid purification vessel 149. Precipitation region 182 is a downflow precipitation region because liquid mixture S_{Mixture2} is precipitated in response to flowing downwardly therethrough.

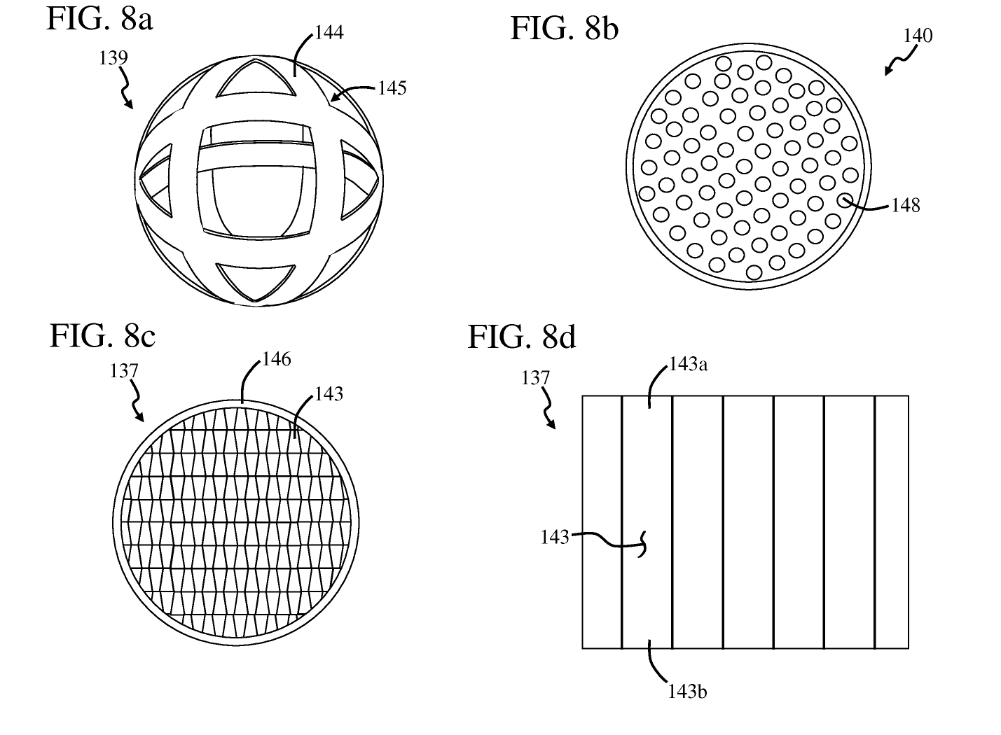

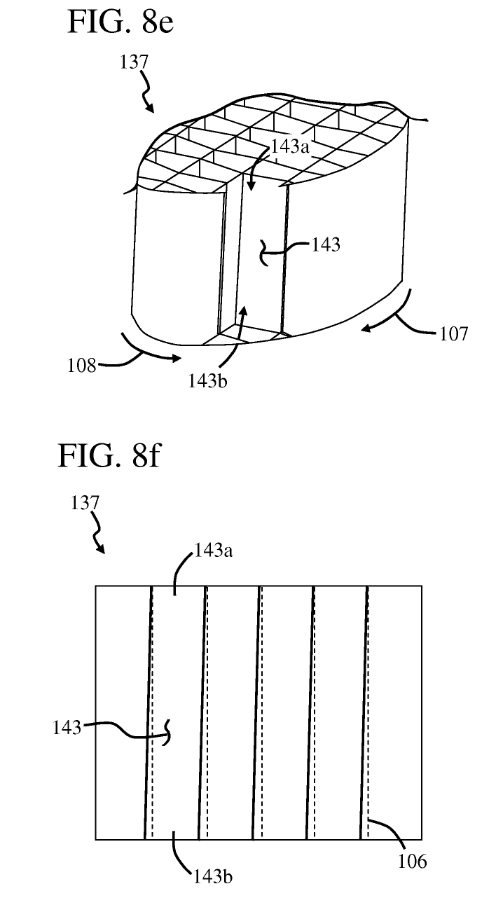

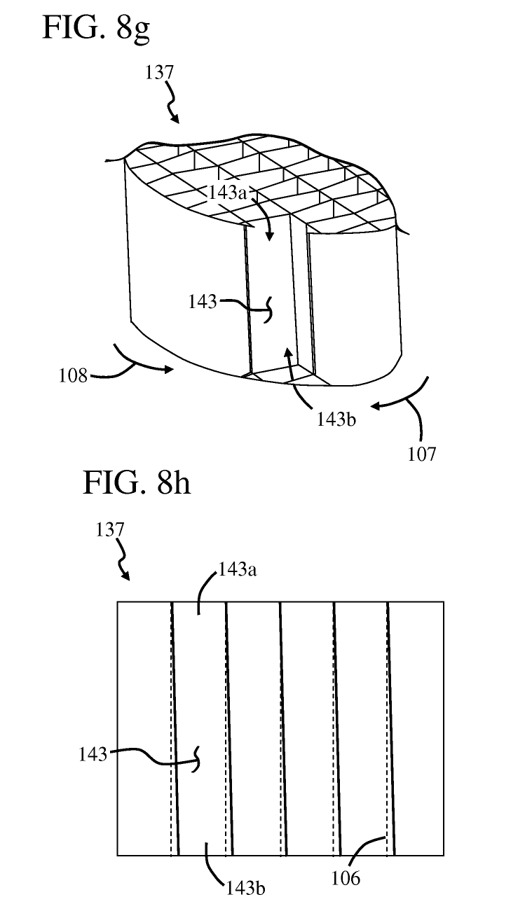

The portion of liquid mixture S_{Mixture2} can be precipitated in downflow precipitation region 182 in many different ways. In this embodiment, downflow precipitation region 182 includes a buoyant precipitation media 138 which includes a plurality of buoyant precipitation elements 139. More information regarding buoyant precipitation element 139 is discussed below with FIG. 8a.

In this embodiment, downflow liquid purification system 130 includes a baffle plate 140 positioned between buoyant precipitation region 138 and upper input port 134. More information regarding baffle plate 140 is discussed below with FIG. 8b. As will be discussed in more detail below, baffle plate 140 is positioned to restrict the ability of buoyant precipitation elements 139 to move between buoyant precipitation region 138 and upper input port 134.

Purified liquid S_{Purified} includes a composition of liquid mixture S_{Mixture2} having a higher concentration of the solvent and lower concentration of the solute. Purified liquid S_{Purified} can be a homogeneous or non-homogeneous liquid mixture. Further, purified liquid S_{Purified} can be a liquid mixture that includes homogeneous and non-homogeneous portions.

Liquid purification vessel 149 provides a downwardly flow of sludge, denoted as S_{Sludge2}, wherein sludge S_{Sludge2} includes the floc particles of the solute of liquid mixture S_{Mixture2}. Sludge S_{Sludge2} includes floc particles of the solute separated from the solvent of liquid mixture S_{Mixture2}. The downflow of sludge S_{Sludge2} is indicated by an arrow labeled S_{Downflow2} in FIG. 7b. The floc particles of sludge S_{Sludge2} are settled in an downflow settling region 183, which extends through a lower portion of downflow liquid purification vessel 149. Settling region 183 is a downflow settling region because liquid mixture S_{Mixture2} flows downwardly therethrough. The floc particles of sludge S_{Sludge2} can be settled in downflow settling region 183 in many different ways. In this embodiment, downflow settling region 183 includes a tube settler 137. More information regarding tube settler 137 is discussed below with FIGS. 8c-8f.

Downflow liquid purification system 130 is a downflow liquid purification system for many different reasons. One reason downflow liquid purification system 130 is an downflow liquid purification system is because liquid mixture S_{Mixture2} is received at an upper portion of downflow liquid purification vessel 149 and purified liquid S_{Purified} is provided from a lower portion of downflow liquid purification vessel 149.

Downflow liquid purification system 130 is a downflow liquid purification system because the flow of liquid mixture S_{Mixture2} through downflow liquid purification vessel 129 is downwardly in a downward direction 105. In particular, downflow liquid purification system 130 is a downflow liquid purification vessel because the flow of liquid mixture S_{Mixture2} therethrough is in the same direction as downward direction 105. It should be noted that the flow of sludge S_{Sludge2} through downflow liquid purification vessel 149 is in downward direction 105. In this way, liquid mixture S_{Mixture2} and sludge S_{Sludge2} flow in the same directions through downflow liquid purification vessel 149.

In this embodiment, purified liquid S_{Purified} is provided from intermediate vessel portion 132 of downflow liquid purification vessel 149. Purified liquid S_{Purified} is provided from intermediate vessel portion 132 of downflow liquid purification vessel 149 because intermediate output port 135 is in fluid communication with lower vessel portion 131 through intermediate vessel portion 132. In particular, intermediate output port 135 is in fluid communication with lower vessel portion 131 through an upflow channel 142 which is established between lower vessel portion 131 and intermediate output port 135. Upflow channel 142 can be established in many different ways, one of which will be discussed in more detail presently.

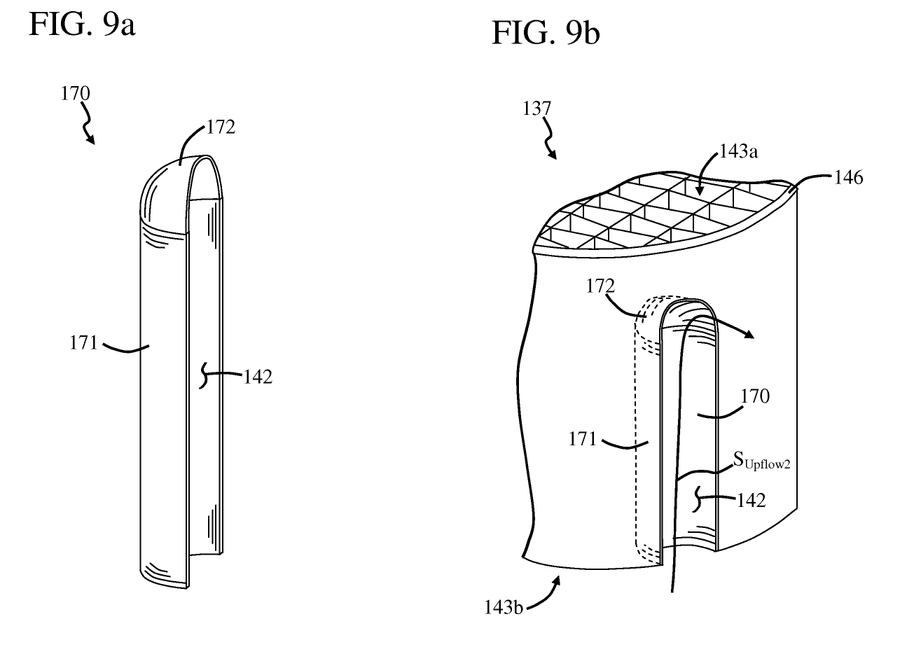

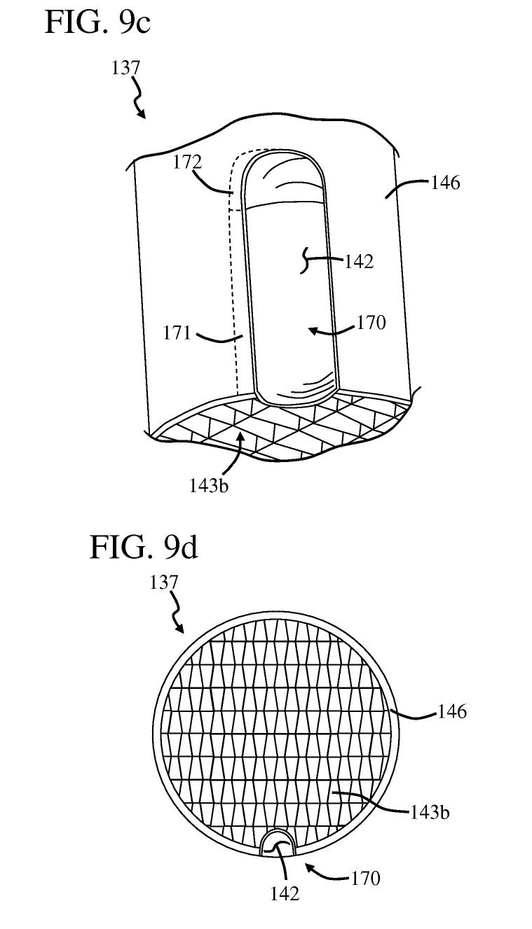

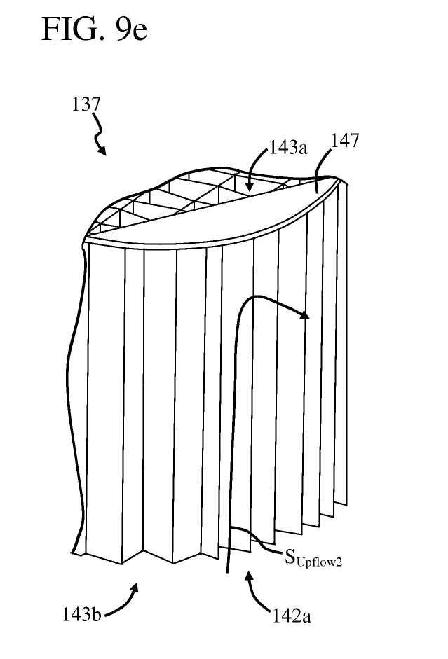

In this embodiment, upflow channel 142 is established by a tube settler shroud 170, wherein tube settler shroud 170 extends between lower vessel portion 131 and intermediate output port 135. In particular, tube settler shroud 170 extends between lower vessel portion 131 and intermediate output port 135 and through tube settler 137. Tube settler shroud 170 can extend through tube settler 137 in many different ways, one of which will be discussed in more detail with FIGS. 9a-9e.

FIG. 8a is a perspective view of one embodiment of precipitation element 139 of buoyant precipitation media 138, as shown in FIG. 7b. More information regarding precipitation elements can be found in U.S. Pat. Nos. 4,200,532 and 6,811,147 and 7,014,175. In this embodiment, precipitation element 139 is spherical in shape and includes precipitation element ribs 144 and precipitation element openings 145. Precipitation element openings 145 facilitate the ability of liquid mixture S_{Upflow1} to flow through downflow precipitation region 182. In particular, precipitation element openings 145 facilitate the ability of liquid mixture S_{Downflow1} to flow through downflow precipitation region 182 and between upper input port 134 and intermediate output port 135.

Precipitation element ribs 144 facilitate the ability of floc particles to be separated from liquid mixture S_{Downflow1}. Precipitation element ribs 144 facilitate the ability of floc particles to be separated from liquid mixture S_{Downflow1} because ribs 144 increase the surface area of precipitation element 139. In general, the amount of floc particles separated from liquid mixture S_{Downflow1} increases and decreases as the surface area of precipitation element 139 increases and decreases, respectively.

It should be noted that the precipitation elements of buoyant precipitation media 138 are submerged during operation of liquid purification system 100. Further, the precipitation elements of buoyant precipitation media 138 include a buoyant material so that they are biased to float. The precipitation elements of buoyant precipitation media 138 are biased to float because they are biased to move in a direction opposed to direction 105 of FIGS. 1a and 1b when submerged. However, as mentioned above, it is desirable to include the precipitation elements in downflow precipitation region 182. Hence, it is desirable to restrict the ability of the precipitation elements to move upwardly away from downflow precipitation region 182 and towards upper input port 134. The ability of the precipitation elements to move upwardly away from downflow precipitation region 182 and towards upper input port 134 can be restricted in many different ways, one of which will be discussed in more detail presently.

FIG. 8b is a perspective view of one embodiment of baffle plate 140. In this embodiment, baffle plate 140 includes a plurality of baffle plate openings 148. Baffle plate openings 148 are sized to allow liquid mixture S_{Downflow1} to flow therethrough. In particular, baffle plate openings 148 are sized to allow liquid mixture S_{Downflow1} to flow through downflow precipitation region 182 and between upper input port 134 and intermediate output port 135.

However, baffle plate openings 148 are sized to restrict the ability of the precipitation elements of buoyant precipitation media 138 to move upwardly away from downflow precipitation region 182 and towards upper input port 134. Baffle plate openings 148 are sized to restrict the ability of the precipitation elements of buoyant precipitation media 138 to move upwardly away from downflow precipitation region 182 and towards upper input port 134 because the size of baffle plate openings 148 is less than the size of the precipitation elements of buoyant precipitation media 138. In this way, the precipitation elements of precipitation media 138 are held in downflow precipitation region 182.

As mentioned above with FIG. 7b, baffle plate 140 is positioned between buoyant precipitation region 138 and upper input port 134. Hence, the precipitation elements of buoyant precipitation media 138 engage baffle plate 140 in response to being submerged because they are buoyant and biased to float.

FIGS. 8c and 8d are top and side views of one embodiment of tube settler 137. More information regarding tube settlers can be found in U.S. Pat. Nos. 3,925,205 and 5,384,178, as well as U.S. Design Pat. No. D255,153. In this embodiment, tube settler 137 includes a tube settler frame 146, which extends around its outer periphery. It should be noted that tube settler 137 is positioned below upper input port 134. The shapes of tube settler 137 and tube setter frame 146 are chosen so that they can be positioned in downflow liquid purification vessel 149, as shown in FIG. 7b. It is desirable for tube settler frame 146 to engage the inner periphery of downflow liquid purification vessel 149 to increase the likelihood that liquid mixture S_{Downflow2} flows downwardly through tube settler 137. Tube settler 137 is positioned between upper input port 134 and intermediate output port 135 so that is it submerged during normal operation of liquid purification system 100.

In this embodiment, tube settler 137 includes a plurality of channels extending therethrough, wherein one channel is denoted as tube settler channel 143. Tube settler channel 143 includes opposed channel openings 143a and 143b, wherein tube settler channel openings 143a and 143b are positioned away from and towards lower vessel portion 131, respectively. It should be noted that channel openings 153a and 153b are positioned below upper input port 134. It should also be noted that tube settler channel 143 of the embodiment of tube settler 117 of FIGS. 8c and 8d extends parallel to direction 105, as shown in FIGS. 1a and 2b.

Liquid mixture S_{Downflow2} flows downwardly through the plurality of tube settler channels of tube settler 137. For example, a portion of liquid mixture S_{Downflow2} flows upwardly through channel 143. In particular, a portion of liquid mixture S_{Downflow2} flows downwardly through channel 143 from channel opening 143a to channel opening 143b. The portion of liquid mixture S_{Downflow2} flowing through channel 143 flows from channel opening 143a to channel opening 143b because, as mentioned above, channel opening 143a is positioned away from lower vessel portion 131 and channel opening 143b is positioned towards lower vessel portion 131.

In this embodiment, opposed channel openings 143a and 143b are aligned with each other because channel 143 extends vertically so that channel opening 143a is positioned above channel opening 143b. In other embodiments, however, channel 143 does not extend vertically so that opposed channel opening 143a and 143b are offset from each other. Examples of offset channel openings will be discussed in more detail presently.

FIGS. 8e and 8f are top perspective and side views, respectively, of one embodiment of tube settler 137 with offset upper and lower channel openings. It should be noted that portions of tube settler channel openings 143a and 143b overlap in a vertical direction. However, a different portion of tube settler channel opening 143b is positioned counter-clockwise relative to tube settler channel 143a. In this way, tube settler channel openings 143a and 143b are offset from each other. It should be noted that the vertical direction is indicated by reference line 106. In this embodiment, reference line 106 is parallel to direction 105, which is discussed in more detail above with FIGS. 1a and 1b. Hence, in this embodiment, tube settler channel openings 143a and 143b are offset from each other so that tube settler channel 143 does not extend parallel to direction 105.

In this embodiment, tube settler channel opening 143b is offset relative to tube settler channel opening 143a so that tube settler channel opening 143b is positioned counter-clockwise relative to tube settler channel 143a. Tube settler channel opening 143b is positioned counter-clockwise relative to tube settler channel opening 143a so that liquid mixture S_{Mixture1} flows downwardly in clockwise direction 107 through channel 143. Further, tube settler channel opening 143b is positioned counter-clockwise relative to tube settler channel opening 143a so that the floc particles of sludge S_{Sludge2} are more likely to settle on sidewall 143c of tube settler 137, wherein sidewall 143c extends along tube settler channel 143 between upper tube settler channel opening 143a and lower tube settler channel opening 143b. In this way, the floc particles of sludge S_{Sludge2} are more likely to agglomerate to form larger floc particles. As mentioned above, the size of the floc particles increases and decreases as the offset between upper and lower channel openings increases and decreases, respectively.

It is desirable to increase the size of the floc particles so they are more likely to flow with the downflow of sludge, which is indicated as S_{Downflow2} in FIGS. 1a and 2b. Floc particles that are more likely to flow with the downflow of sludge are more likely to flow through sludge output port 116.

Further, it is desirable to increase the size of the floc particles so they are less likely to flow with the downflow of liquid mixture, which is indicated as S_{Downflow2} in FIGS. 1a and 2b. Floc particles that are less likely to flow with the downflow of liquid mixture are less to flow through upper output port 115.

FIGS. 8g and 8h are top perspective and side views, respectively, of one embodiment of tube settler 137 with offset upper and lower channel openings. It should be noted that portions of tube settler channel openings 143a and 143b overlap in a vertical direction. However, a different portion of tube settler channel opening 143b is positioned clockwise relative to tube settler channel 143a. In this way, tube settler channel openings 143a and 143b are offset from each other. It should be noted that the vertical direction is indicated by reference line 106. In this embodiment, reference line 106 is parallel to direction 105, which is discussed in more detail above with FIGS. 1a and 1b. Hence, in this embodiment, tube settler channel openings 143a and 143b are offset from each other so that tube settler channel 143 does not extend parallel to direction 105.

In this embodiment, tube settler channel opening 143b is offset relative to tube settler channel opening 143a so that tube settler channel opening 143b is positioned counter-clockwise relative to tube settler channel 143a. Tube settler channel opening 143b is positioned counter-clockwise relative to tube settler channel opening 143a so that liquid mixture S_{Purified} flows downwardly in counter-clockwise direction 108 through channel 143. Further, tube settler channel opening 143b is positioned counter-clockwise relative to tube settler channel opening 143a so that the floc particles of sludge S_{Sludge2} are more likely to settle on sidewall 143c of tube settler 137, wherein sidewall 143c extends along tube settler channel 143 between upper tube settler channel opening 143a and lower tube settler channel opening 143b. In this way, the floc particles of sludge S_{Sludge2} are more likely to agglomerate to form larger floc particles. As mentioned above, the size of the floc particles increases and decreases as the offset between upper and lower channel openings increases and decreases, respectively.

It should be noted that it is useful to connect lower input port 114 to lower vessel portion 111 so that liquid mixture S_{Purified} flows in clockwise direction 107 when tube settler 137 of FIGS. 6e and 6f is included with downflow liquid purification system 110. One way to connect lower input port 114 to lower vessel portion 111 so that liquid mixture S_{Purified} flows in clockwise direction 107 is disclosed in FIGS. 5a-5d.

As mentioned above, it is desirable to increase the size of the floc particles so they are more likely to flow with the downflow of sludge, which is indicated as S_{Downflow2} in FIGS. 1a and 2b. Floc particles that are more likely to flow with the downflow of sludge are more likely to flow through sludge output port 116.

Further, it is desirable to increase the size of the floc particles so they are less likely to flow with the downflow of liquid mixture, which is indicated as S_{Downflow2} in FIGS. 1a and 2b. Floc particles that are less likely to flow with the downflow of liquid mixture are less to flow through upper output port 115.

FIG. 9a is a perspective view of tube settler shroud 170. As mentioned above, tube settler shroud 170 is used to establish upflow channel 142, as shown in FIG. 7b. In this embodiment, tube settler shroud 170 includes a tube settler shroud body 171 and tube settler shroud head 172, wherein tube settler shroud head 172 is positioned proximate to an upper end of tube settler shroud body 171. Tube settler shroud body 171 has a U-shaped cross-sectional shape and forms a tube settler shroud channel 173 which extends along the length of tube settler shroud body 171 to tube settler shroud head 172. Tube settler shroud 170 allows a portion of liquid mixture S_{Downflow1} to flow upwardly to intermediate output port 135, as will be discussed in more detail presently.

FIGS. 9b and 9c are upper and lower perspective views of tube settler shroud 170 coupled to tube settler 137. FIG. 9d is a top view of tube settler 137 and tube settler shroud 170 of FIGS. 9b and 9c. Tube settler shroud 170 can be coupled to tube settler 137 in many different ways. In this embodiment, tube settler shroud 170 extends through tube settler frame 146 so that tube settler shroud channel 173 faces outwardly therefrom. Tube settler shroud 170 is coupled to tube settler frame 146 so that tube settler shroud body 171 extends between tube settler shroud channel 173 and tube settler 137. Further, tube settler shroud 170 is coupled to tube settler frame 146 so that tube settler shroud head 172 is positioned proximate to intermediate output port 135, as shown in FIG. 7b.

In this embodiment, tube settler shroud head 172 is positioned towards tube settler channel 143a and away from tube settler channel 143b, as shown in FIG. 9b. Further, the opposed end of tube settler shroud 170 is positioned towards tube settler channel 143b and away from tube settler channel 143a, as shown in FIG. 9c. In this way, tube settler shroud channel 173 extends upwardly from tube settler channel 143b towards tube settler channel 143a. It should be noted that tube settler channel 143b is in fluid communication with intermediate output port 135 through tube settler shroud channel 173.

FIG. 9e is another embodiment of upflow channel 142, denoted as upflow channel 142a. In this embodiment, tube settler 137 carries a tube seller plate 147 proximate to tube settler channel opening 143a and away from tube settler channel opening 143b. Tube seller plate 147 restricts the ability of fluid to flow through selected tube settler channels 143. In particular, tube seller plate 147 restricts the ability of fluid to flow through selected tube settler channel openings 143a towards corresponding tube settler channel openings 143b. However, tube seller plate 147 allows the ability of fluid to flow through selected tube settler channel openings 143b towards corresponding tube settler channel openings 143a. In this way, upflow channel 142a includes a portion of selected tube settler channels 143.

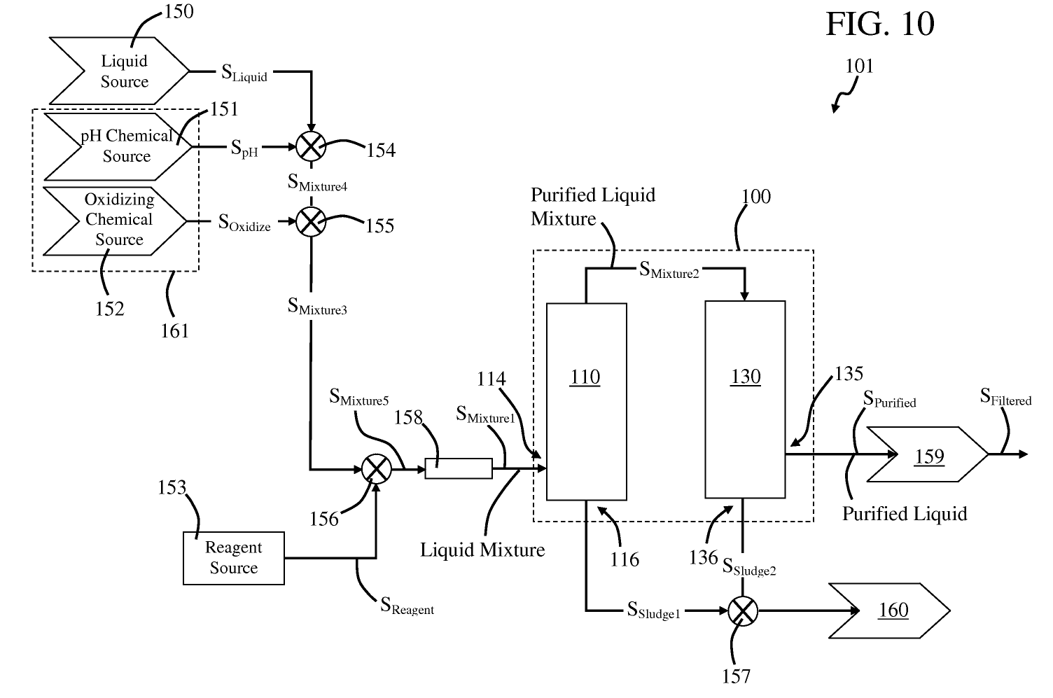

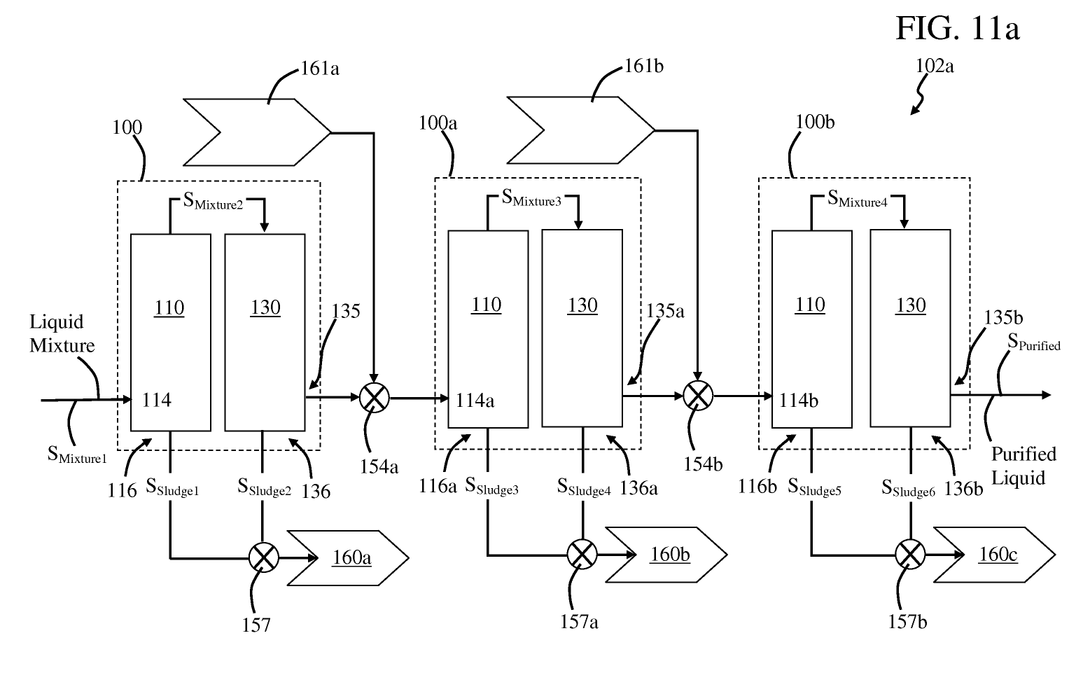

FIG. 10 is another embodiment of a liquid purification system, which is denoted as liquid purification system 101. In this embodiment, liquid purification system 101 includes liquid purification system 100, which receives liquid mixture S_{Mixture1} and provides purified liquid S_{Purified} in response. Liquid mixture S_{Mixture1} can be provided to liquid purification system 100 in many different ways, one of which will be discussed in more detail presently.

In this embodiment, liquid purification system 101 includes a liquid source 150 which provides raw water, denoted as S_{Liquid}, to a liquid coupler 154. As mentioned above, raw water is a mixture of desired drinking water and undesired solid contaminants. Liquid purification system 101 includes a pH chemical source 151 which provides a pH chemical, denoted as S_{pH}, to liquid coupler 154. Liquid coupler 154 combines raw water S_{Liquid} and pH chemical S_{pH} together to form a liquid mixture S_{Mixture4}.

In this embodiment, liquid purification system 101 includes an oxidizing chemical source 152 which provides an oxidizing chemical, denoted as S_{Oxidize}, to a liquid coupler 155. Liquid coupler 155 receives liquid mixture S_{Mixture4} from liquid coupler 154 and combines it with oxidizing chemical S_{Oxidize}. It should be noted that pH chemical source 151 and oxidizing chemical source 152 are included in a chemical conditioning system 161.

In this embodiment, liquid purification system 101 includes a reagent source 153 which provides a reagent chemical, denoted as S_{Reagent}, to a liquid coupler 156. Liquid coupler 156 receives liquid mixture S_{Mixture3} from liquid coupler 155 and combines it with reagent chemical S_{Reagentt} to provide a liquid mixture S_{Mixture5}.

In this embodiment, liquid purification system 101 includes a liquid mixer 158 which receives liquid mixture S_{Mixture5} at a mixer input and provides liquid mixture S_{Mixture1} at a mixer output. It should be noted that liquid mixture S_{Mixture5} includes raw water S_{Liquid}, pH chemical S_{pH}, oxidizing chemical S_{Oxidize} and reagent chemical S_{Reagent} combined together, as discussed above. Hence, liquid mixture S_{Mixture1} includes raw water S_{Liquid}, pH chemical S_{pH}, oxidizing chemical S_{Oxidize} and reagent chemical S_{Reagent} mixed together in response to flowing through liquid mixer 158. In this way, liquid mixture S_{Mixture1} is provided to liquid purification system 100.

The pH level of raw water S_{Liquid} is adjusted in response to being mixed with pH chemical S_{pH} by liquid mixer 158. The pH level of a solution corresponds to its acidity or basicity, and the pH level of freshly distilled water is said to be neutral. The pH chemical S_{pH} can include many different types of chemicals, such as carbon dioxide.

The oxidation level of raw water S_{Liquid} is adjusted in response to being mixed with oxidizing chemical S_{Oxidize} by liquid mixer 158. Raw water S_{Liquid} is oxidized in response to being mixed with oxidizing chemical S_{Oxidize}. The oxidizing chemical S_{Oxidize} can include many different types of oxidizing chemicals, such as ozone.

Reagent chemical S_{Reagent} provides reagent floc particles to raw water S_{Liquid}, wherein the reagent floc particles facilitate the ability for the undesired solid contaminants of raw water S_{Liquid} to agglomerate. Reagent chemical S_{Reagent} can be of many different types of reagent chemicals, such as ferric chloride. The floc particles provided by reagent chemical S_{Reagent} facilitate the ability of liquid mixture S_{Mixture1} to be precipitated.

In this embodiment, liquid purification system 101 includes a combiner 157 in fluid communication with sludge output ports 116 and 136. Combiner 157 receives flows of sludge S_{Sludge1} and S_{Sludge2} from output ports 116 and 136, respectively, and combines them so they are provided to an input port of a sludge collector 160. In this way, sludge is removed from liquid purification system 100.

In this embodiment, liquid purification system 101 includes a liquid filter 159 in fluid communication with sludge intermediate output port 135. Liquid filter 159 receives purified liquid S_{Purified} from intermediate output port 135 and provides a filtered liquid S_{Filtered} in response. Liquid filter 159 can be of many different types of filters, such as a sand filter and organic filter.

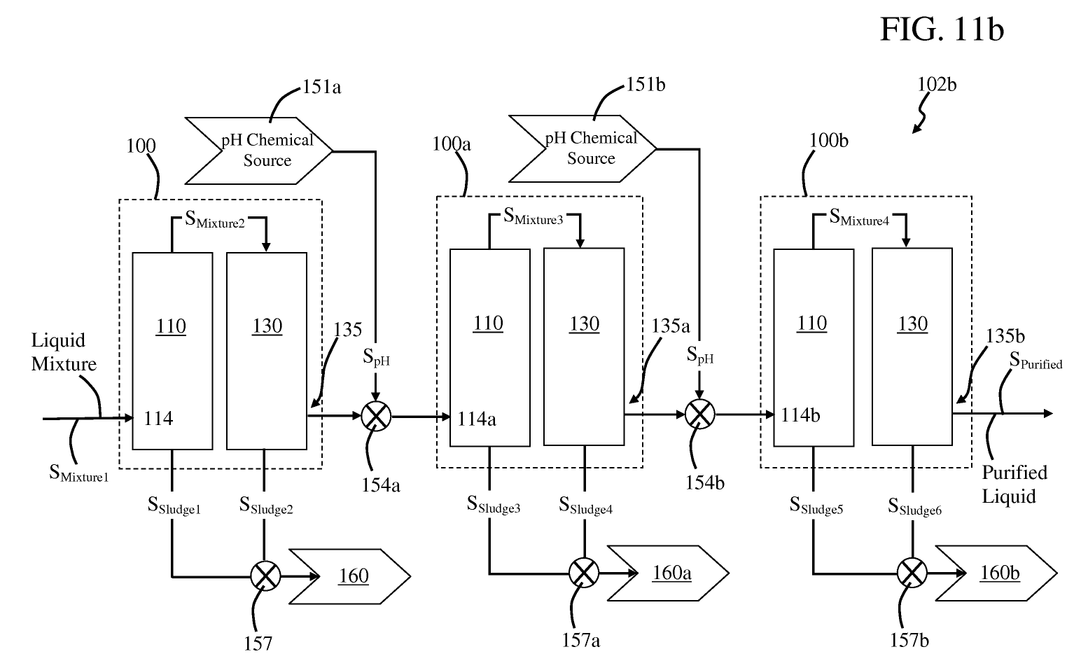

FIG. 11a is another embodiment of a liquid purification system, denoted as liquid purification system 102a. In this embodiment, liquid purification system 102a includes liquid purification system 101, as discussed with FIG. 10.

In this embodiment, liquid purification system 102a includes a liquid purification system 100a connected in series with liquid purification system 100. In particular, liquid purification system 100 includes a lower input port 114a in fluid communication with intermediate output port 135. In this embodiment, lower input port 114a is in fluid communication with intermediate output port 135 through a liquid coupler 154a, wherein liquid coupler 154a is in fluid communication with a chemical conditioning system 161a. Chemical conditioning system 161a can be of many different types, such as chemical conditioning system 161, which is discussed in more detail with FIG. 10.

Chemical conditioning system 161a provides a desired chemical mixture to the fluid flowing between intermediate output port 135 and lower input port 114a. In this way, the fluid flowing between intermediate output port 135 and lower input port 114a is conditioned. For example, in some situations, the pH of the fluid flowing between intermediate output port 135 and lower input port 114a is adjusted to drive it to a desired pH level, as discussed in more detail above with FIG. 10. In some situations, the fluid flowing between intermediate output port 135 and lower input port 114a is oxidized by a desired amount, as discussed in more detail above with FIG. 10.

In this embodiment, liquid purification system 102a includes a liquid purification system 100b connected in series with liquid purification system 100a. In particular, liquid purification system 100 includes a lower input port 114b in fluid communication with an intermediate output port 135a of liquid purification system 100a. In this embodiment, lower input port 114b is in fluid communication with intermediate output port 135a through a liquid coupler 154b, wherein liquid coupler 154b is in fluid communication with a chemical conditioning system 161b. Chemical conditioning system 161b can be of many different types, such as chemical conditioning system 161, which is discussed in more detail with FIG. 10.

Chemical conditioning system 161b provides a desired chemical mixture to the fluid flowing between intermediate output port 135a and lower input port 114b. In this way, the fluid flowing between intermediate output port 135a and lower input port 114b is conditioned. For example, in some situations, the pH of the fluid flowing between intermediate output port 135a and lower input port 114ba is adjusted to drive it to a desired pH level, as discussed in more detail above with FIG. 10. In some situations, the fluid flowing between intermediate output port 135a and lower input port 114b is oxidized by a desired amount, as discussed in more detail above with FIG. 10.

It should be noted that, in some embodiments, liquid purification system 102a includes a chemical conditioning system (not shown) in fluid communication with intermediate output port 135b, wherein the chemical conditioning system oxidizes the fluid flow therethrough to reduce it by a desired amount.

It should be noted that, in some embodiments, liquid purification system 102a includes a chemical conditioning system (not shown) in fluid communication with intermediate output port 135b, wherein the chemical conditioning system drives the pH of the fluid flow therethrough to a neutral pH level.

It should be noted that liquid purification system 102a allows different types of floc particles to be targeted for filtering. For example, liquid purification systems 100, 100a and 100b are capable of targeting floc particles of first, second and third materials, respectively, by adjusting the pH and/or oxidation of the fluid flow using chemical conditioning systems 161, 161a and 161b, respectively. In this way, liquid purification systems 100 outputs a downwardly flow of sludge S_{Sludge1} and S_{Sludge2} from sludge output ports 116 and 136, respectively, as discussed in more detail above. Further, liquid purification systems 100a outputs a downwardly flow of sludge S_{Sludge3} and S_{Sludge4} from sludge output ports 116a and 136a, respectively, and liquid purification systems 100b outputs a downwardly flow of sludge S_{Sludge5} and S_{Sludge6} from sludge output ports 116b and 136b, respectively.

It should be noted that, in general, the material of sludge S_{Sludge1} and S_{Sludge2} is different from the material of S_{Sludge3} and S_{Sludge4}. Further, in general, the material of sludge S_{Sludge1} and S_{Sludge2} is different from the material of S_{Sludge5} and S_{Sludge6}. The type of material of sludge S_{Sludge1} and S_{Sludge2} is controlled by controlling the chemicals of chemical conditioning system 161.

It should be noted that, in general, the material of sludge S_{Sludge3} and S_{Sludge4} is different from the material of S_{Sludge1} and S_{Sludge2}. Further, in general, the material of sludge S_{Sludge3} and S_{Sludge4} is different from the material of S_{Sludge5} and S_{Sludge6}. The type of material of sludge S_{Sludge1} and S_{Sludge2} is controlled by controlling the chemicals of chemical conditioning system 161a.

It should be noted that, in general, the material of sludge S_{Sludge5} and S_{Sludge6} is different from the material of S_{Sludge1} and S_{Sludge2}. Further, in general, the material of sludge S_{Sludge5} and S_{Sludge6} is different from the material of S_{Sludge3} and S_{Sludge4}. The type of material of sludge S_{Sludge1} and S_{Sludge2} is controlled by controlling the chemicals of chemical conditioning system 161b.

In this way, liquid purification system 102a outputs sludge having different types of material so the materials are separated from each other.

FIG. 11b is another embodiment of a liquid purification system, denoted as liquid purification system 102b. In this embodiment, liquid purification system 102b includes liquid purification system 102a, as discussed with FIG. 10. However, chemical conditioning system 161a includes a pH chemical source 151a and chemical conditioning system 161b includes a pH chemical source 151b.

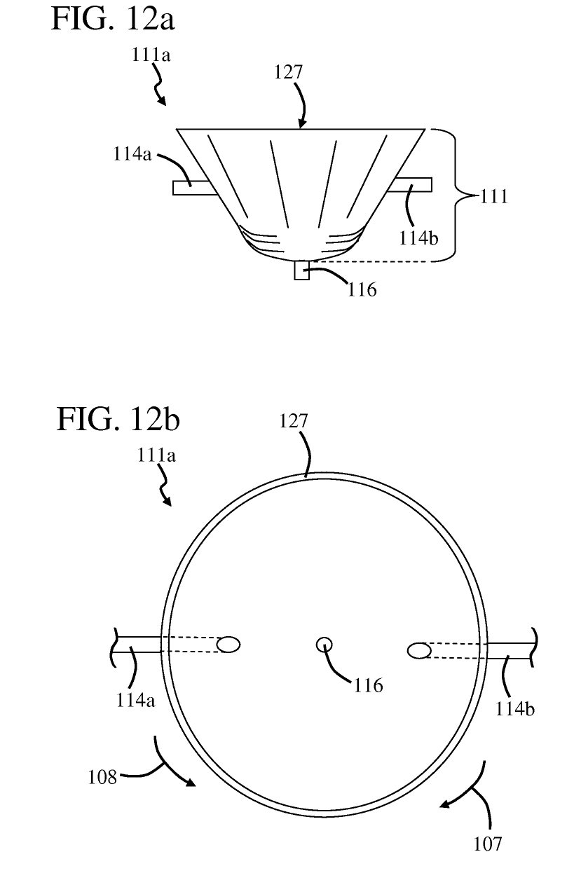

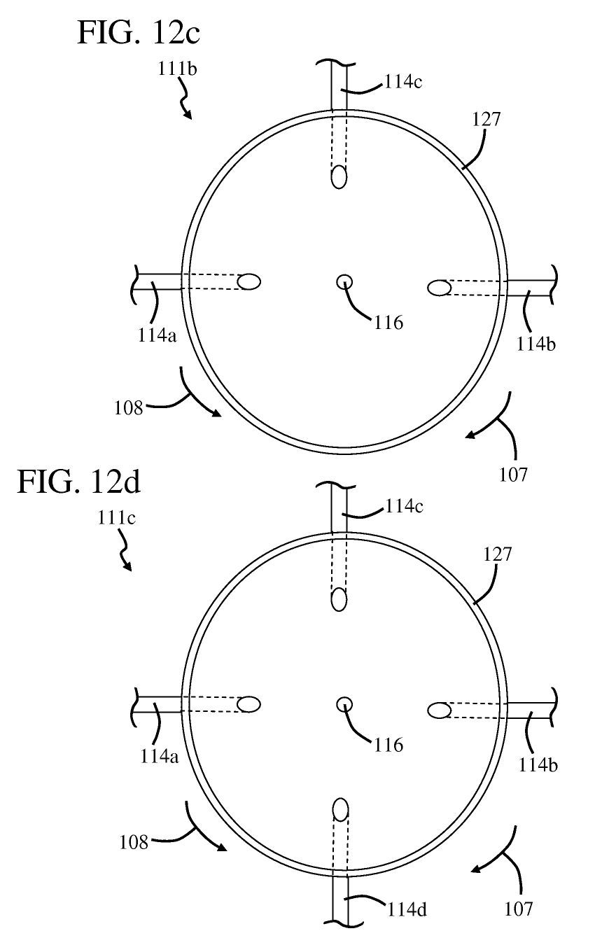

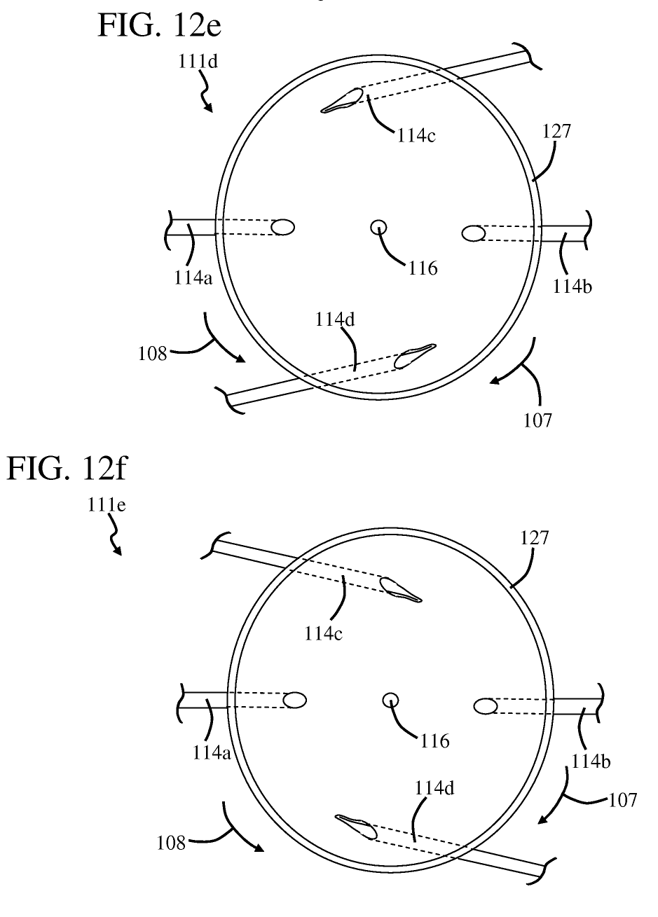

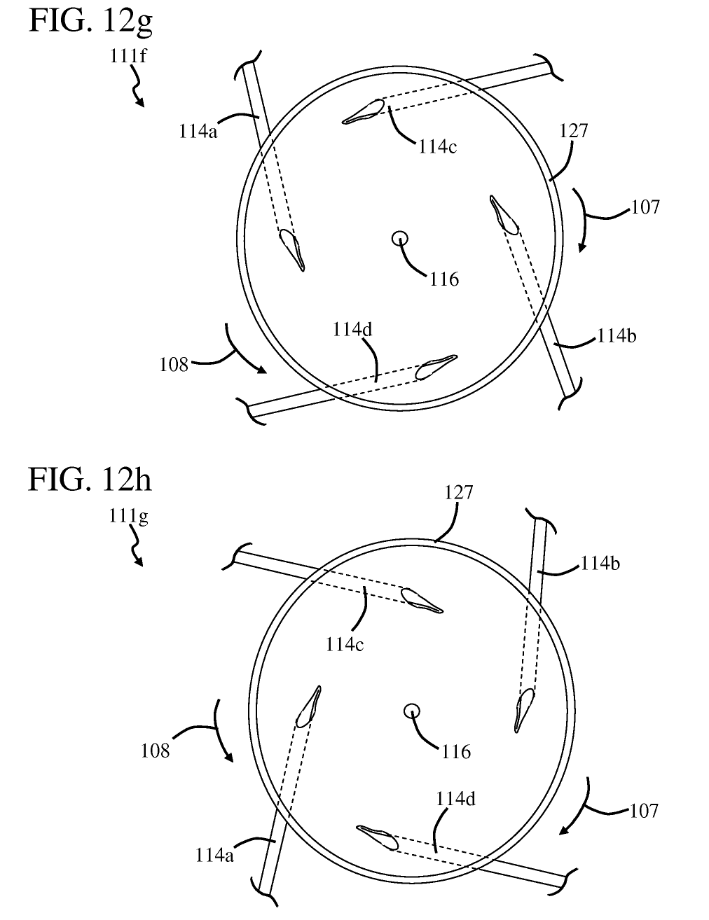

FIG. 12a is a side view of an embodiment of a lower vessel portion, which is denoted as lower vessel portion 111a. FIG. 12b is a top view of lower vessel portion 111a. In this embodiment, lower vessel portion 111a includes lower vessel portion 111 and lower input ports 114a and 114b, which are opposed from each other. Lower input ports 114a and 114b oppose each other so that the fluid flowing from them is directed to a region of lower vessel portion 111 above sludge output port 116. The flow of fluid through lower input ports 114a and 114b is controllable to provide a desired amount of fluid mixing. It should be noted that, in some situations, lower input ports 114a and 114b are in fluid communication with the same liquid source and, in other situations, lower input ports 114a and 114b are in fluid communication with different liquid sources. In this way, liquid purification system 102b can received a fluid flow from one or more liquid sources.

FIG. 12c is a top view of an embodiment of a lower vessel portion, which is denoted as lower vessel portion 111b. In this embodiment, lower vessel portion 111b includes lower vessel portion 111 and lower input ports 114a and 114b, which are opposed from each other, and a lower input port 114c which extends perpendicular to lower input ports 114a and 114b. Lower input ports 114a and 114b oppose each other so that the fluid flowing from them is directed to a region of lower vessel portion 111 above sludge output port 116. The flow of fluid through lower input ports 114a and 114b is controllable to provide a desired amount of fluid mixing. Further, lower input port 114c is directed to the region of lower vessel portion 111 above sludge output port 116. The flow of fluid through lower input ports 114a and 114b and 114c is controllable to provide a desired amount of fluid mixing. It should be noted that, in some situations, lower input ports 114a, 114b and 114c are in fluid communication with the same liquid source and, in other situations, lower input ports 114a, 114b and 114c are in fluid communication with different liquid sources. In some situations, lower input ports 114a and 114b are in fluid communication with the same liquid source, and lower input port 114c is in fluid communication with a different liquid source. In this way, the liquid purification system can received a fluid flow from one, two or three liquid sources.

FIG. 12d is a top view of an embodiment of a lower vessel portion, which is denoted as lower vessel portion 111c. In this embodiment, lower vessel portion 111b includes lower vessel portion 111 and lower input ports 114a and 114b, which are opposed from each other, and lower input ports 114c and 114d which extend perpendicular to lower input ports 114a and 114b. Lower input ports 114a and 114b oppose each other so that the fluid flowing from them is directed to a region of lower vessel portion 111 above sludge output port 116. The flow of fluid through lower input ports 114a and 114b is controllable to provide a desired amount of fluid mixing. Further, lower input ports 114c and 114d are directed to the region of lower vessel portion 111 above sludge output port 116. The flow of fluid through lower input ports 114a and 114b and 114c and 114d is controllable to provide a desired amount of fluid mixing.

FIG. 12e is a top view of an embodiment of a lower vessel portion, which is denoted as lower vessel portion 111d. In this embodiment, lower vessel portion 111b includes lower vessel portion 111 and lower input ports 114a and 114b, which are opposed from each other, and lower input ports 114c and 114d which extend as discussed in more detail above with FIG. 4a. Lower input ports 114a and 114b oppose each other so that the fluid flowing from them is directed to a region of lower vessel portion 111 above sludge output port 116. The flow of fluid through lower input ports 114a and 114b is controllable to provide a desired amount of fluid mixing. Further, lower input ports 114c and 114d are directed as discussed above with FIG. 4a. The flow of fluid through lower input ports 114a and 114b and 114c and 114d is controllable to provide a desired amount of fluid mixing.

FIG. 12f is a top view of an embodiment of a lower vessel portion, which is denoted as lower vessel portion 111e. In this embodiment, lower vessel portion 111b includes lower vessel portion 111 and lower input ports 114a and 114b, which are opposed from each other, and lower input ports 114c and 114d which extend as discussed in more detail above with FIG. 5a. Lower input ports 114a and 114b oppose each other so that the fluid flowing from them is directed to a region of lower vessel portion 111 above sludge output port 116. The flow of fluid through lower input ports 114a and 114b is controllable to provide a desired amount of fluid mixing. Further, lower input ports 114c and 114d are directed as discussed above with FIG. 5a. The flow of fluid through lower input ports 114a and 114b and 114c and 114d is controllable to provide a desired amount of fluid mixing.

FIG. 12g is a top view of an embodiment of a lower vessel portion, which is denoted as lower vessel portion 111f. In this embodiment, lower vessel portion 111b includes lower vessel portion 111 and lower input ports 114a and 114b and lower input ports 114c and 114d, which are extend as discussed in more detail above with FIG. 4a. The flow of fluid through lower input ports 114a and 114b and 114c and 114d is controllable to provide a desired amount of fluid mixing.

FIG. 12h is a top view of an embodiment of a lower vessel portion, which is denoted as lower vessel portion 111g. In this embodiment, lower vessel portion 111b includes lower vessel portion 111 and lower input ports 114a and 114b and lower input ports 114c and 114d, which are extend as discussed in more detail above with FIG. 5a. The flow of fluid through lower input ports 114a and 114b and 114c and 114d is controllable to provide a desired amount of fluid mixing. It should be noted that, in general, one or more input ports can be included as discussed above, so that the liquid purification system can received a fluid flow one or more liquid sources.

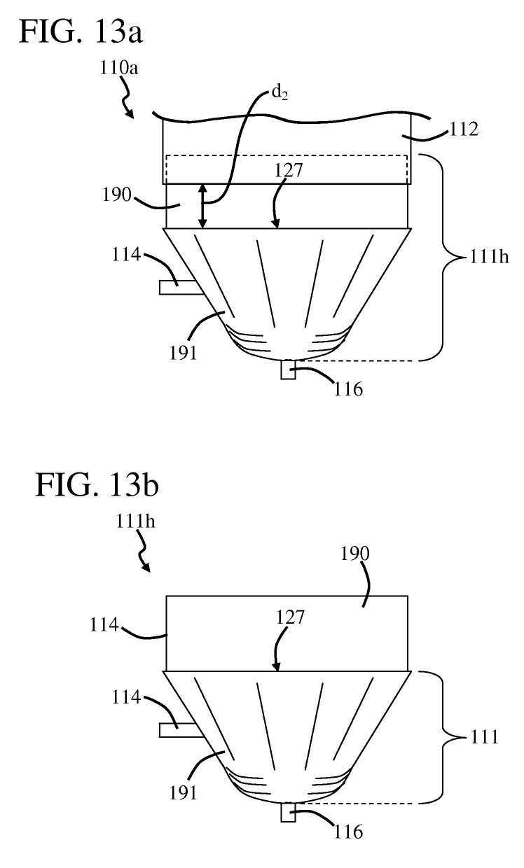

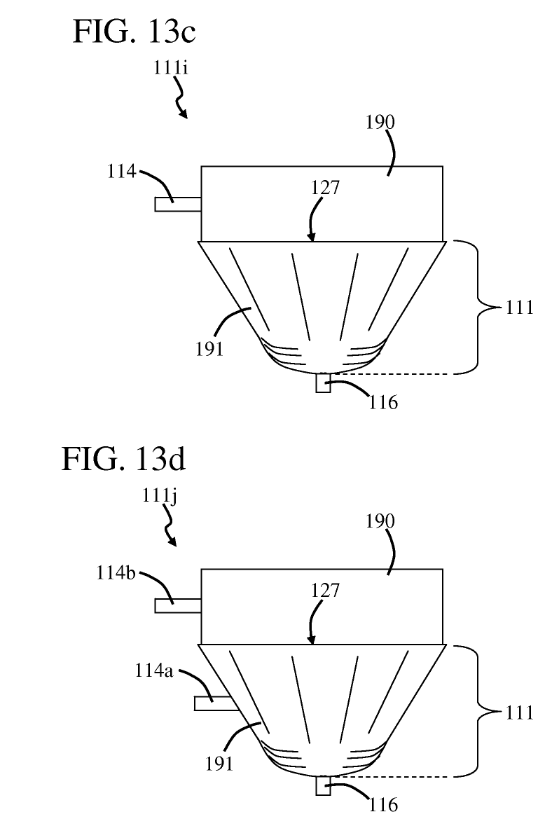

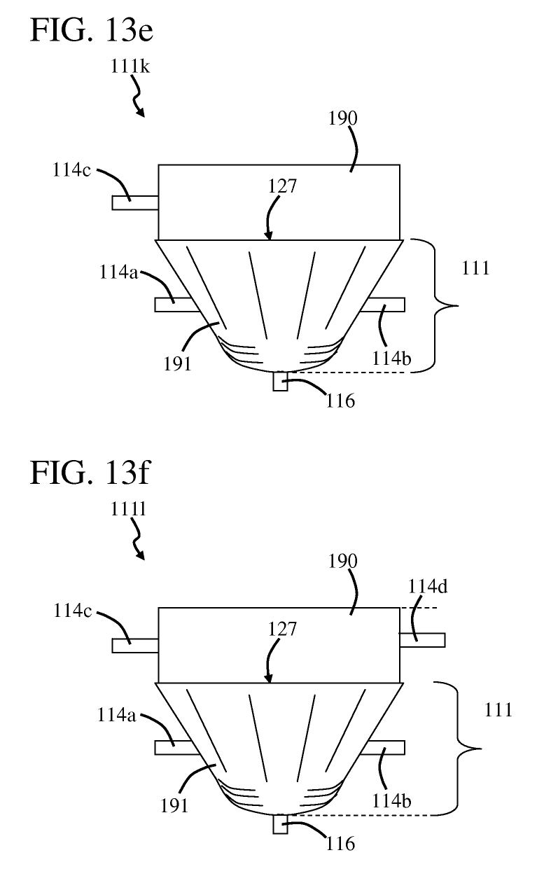

FIG. 13a is a side view of an embodiment of an upflow liquid purification system, denoted as upflow liquid purification system 110a. In this embodiment, upflow liquid purification system 110a includes a flanged lower vessel portion, denoted as flanged lower vessel portion 111h. In this embodiment, flanged lower vessel portion 111h includes lower vessel portion 111 and a lower vessel flange 190 extending upwardly from conical chamber sidewall rim 127, as shown in a side view in FIG. 13b. It should be noted that lower vessel flange 190 extends annularly around conical chamber sidewall rim 127, and facilitates the ability of intermediate vessel portion 112 to be coupled to lower vessel portion 111. In some situations, lower vessel portion 111 and intermediate vessel portion 112 are welded together, and lower vessel flange 190 allows intermediate vessel portion 112 to be positioned relative to lower vessel portion 111 so they can be welded together at conical chamber sidewall rim 127. It should be noted that, in some embodiments, intermediate vessel portion 112 is welded to lower vessel flange 190 so that intermediate vessel portion 112 is spaced from conical chamber sidewall rim 127. For example, intermediate vessel portion 112 can be welded to lower vessel flange 190 so that intermediate vessel portion 112 is spaced a distance d₂ from conical chamber sidewall rim 127, as shown in FIG. 13a. Distance d₂ can be chosen to provide a desired amount of mixing of the fluids which flow through the lower input ports of the upflow liquid purification system. It is desirable to choose distance d₂ so that precipitated floc particles flow downwardly away from the mixing zone, which reduces the likelihood that the precipitated floc particles will be undesirably mixed with fluid flow S_{Upflow1} (FIG. 2b).

FIG. 13c is a side view of another embodiment of a flanged lower vessel portion, which is denoted as flanged vessel portion 111i. In this embodiment, lower input port 114 extends through lower vessel flange 190 instead of lower vessel portion 111. In this embodiment, intermediate vessel portion 112 is welded to lower vessel flange 190 so that intermediate vessel portion 112 is spaced from conical chamber sidewall rim 127. Intermediate vessel portion 112 is welded to lower vessel flange 190 so that lower input port 114 is positioned between intermediate vessel portion 112 and conical chamber sidewall rim 127.

FIG. 13d is a side view of another embodiment of a flanged lower vessel portion, which is denoted as flanged vessel portion 111j. In this embodiment, lower input port 111a extends through lower vessel portion 111 and lower input port 114b extends through lower vessel flange 190. It should be noted that, in some situations, the fluid flows through lower input port 114b when it is desired to mix it less and, in other situations, the fluid flows through lower input port 114a when it is desired to mix it less. The fluid is mixed more in response to flowing through lower input port 114a and the fluid is mixed less in response to flowing through lower input port 114b because the fluid flowing through lower input port 114a will engage conical chamber sidewall 122, as discussed in more detail above with FIGS. 2a and 2b and 3a and 3b.

FIG. 13e is a side view of another embodiment of a flanged lower vessel portion, which is denoted as flanged vessel portion 111k. In this embodiment, lower input ports 111a and 111b extend through lower vessel portion 111, as shown in FIGS. 12a and 12b, and lower input port 114c extends through lower vessel flange 190.

FIG. 13f is a side view of another embodiment of a flanged lower vessel portion, which is denoted as flanged vessel portion 111i. In this embodiment, lower input ports 111a and 111b extend through lower vessel portion 111, as shown in FIGS. 12a and 12b, and lower input port 114c and 114d extend through lower vessel flange 190 so they are opposed to each other.

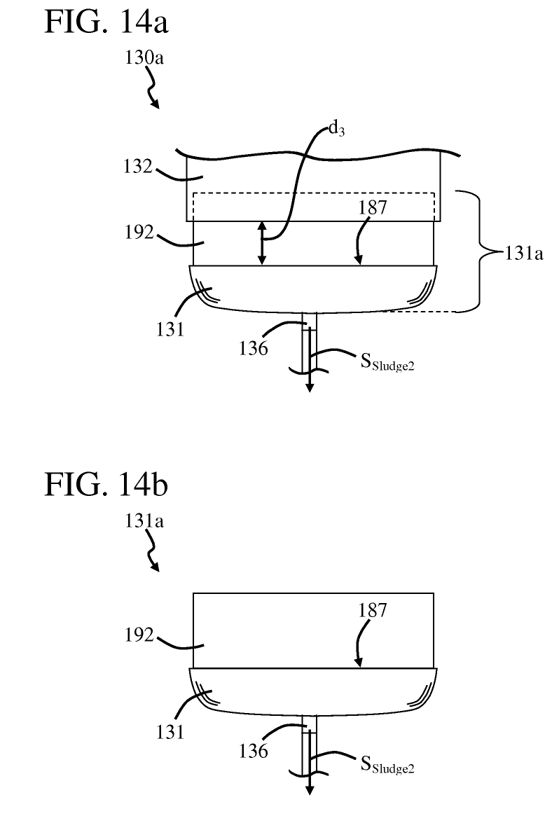

FIG. 14a is a side view of one embodiment of a downflow liquid purification system, denoted as downflow liquid purification system 130a. In this embodiment, downflow liquid purification system 130a includes a flanged lower vessel portion, denoted as flanged lower vessel portion 131a. In this embodiment, flanged lower vessel portion 131a includes lower vessel portion 131 and a lower vessel flange 192 extending upwardly from a rim 187, as shown in a side view in FIG. 14b. It should be noted that lower vessel flange 192 extends annularly around rim 187, and facilitates the ability of intermediate vessel portion 132 to be coupled to lower vessel portion 131. In some situations, lower vessel portion 131 and intermediate vessel portion 132 are welded together, and lower vessel flange 192 allows intermediate vessel portion 132 to be positioned relative to lower vessel portion 131 so they can be welded together at rim 187.

It should be noted that, in some embodiments, intermediate vessel portion 112 is welded to lower vessel flange 192 so that intermediate vessel portion 132 is spaced from rim 187. For example, intermediate vessel portion 112 can be welded to lower vessel flange 192 so that intermediate vessel portion 132 is spaced a distance d₃ from rim 187, as shown in FIG. 14a. Distance d₃ can be chosen to provide a desired amount of separation between flows S_{Upflow2} and S_{Sludge2}, as shown in FIG. 7a. In general, it is desirable to increase distances d₁ and d₂ in response to having more solute in the liquid mixture. Further, it is desirable to decrease distances d₁ and d₂ in response to having less solute in the liquid mixture. It is desirable to choose distance d₃ so that precipitated floc particles flow downwardly away from upflow channel 142, which reduces the likelihood that the precipitated floc particles will be undesirably mixed with fluid flow S_{Upflow2} (FIG. 7b).

Hence, disclosed is a liquid purification system which allows the control of the mixing rate, the pH level and the oxidation of a fluid flow so that the fluid flow can be purified. The desired mixing rate depends on many different factors, such as the temperature of the fluid flow and the solute desired to be removed from the fluid flow. The mixing rate also depends on the mixing energy. The mixing energy can be driven to a desired amount to facilitate the separation of the solute from the solution.

The embodiments of the invention described herein are exemplary and numerous modifications, variations and rearrangements can be readily envisioned to achieve substantially equivalent results, all of which are intended to be embraced within the spirit and scope of the invention.

1. A liquid purification system, comprising:
an upflow liquid purification system which receives a first flow of liquid, wherein the upflow liquid purification system treats the liquid in response to the liquid flowing upwardly through the upflow liquid purification system;
a downflow liquid purification vessel which receives a first flow of liquid, wherein the upflow liquid purification system treats the liquid in response to the liquid flowing upwardly through the upflow liquid purification system.

2. The system of claim 1, wherein the upflow liquid purification system provides a downflow of sludge in response to receiving the first flow of liquid.

3. The system of claim 1, wherein the upflow liquid purification system provides an upflow of treated liquid in response to receiving the first flow of liquid and providing the downflow of sludge.

4. The system of claim 1, wherein the upflow liquid purification system receives the first flow of liquid at a lower vessel portion and provides the upflow of treated liquid at an upper vessel portion.

5. The system of claim 1, wherein the upflow liquid purification system provides the flow of sludge and the upflow of treated liquid in opposed directions.

6. The system of claim 1, wherein the upflow of the first liquid flows against gravity.

7. The system of claim 1, wherein the downflow liquid purification vessel provides a downflow of sludge in response to receiving the first flow of liquid.

8. The system of claim 1, wherein the downflow liquid purification vessel provides an outflow of treated liquid in response to receiving the first flow of liquid and providing the downflow of sludge.

9. The system of claim 1, wherein the downflow liquid purification vessel receives the first flow of liquid at an upper vessel portion and provides the downflow of sludge at a lower vessel portion.

10. The system of claim 1, wherein the downflow liquid purification vessel receives the flow of sludge and the downflow of treated liquid in the same direction.

11. The system of claim 1, wherein the downflow of the first liquid flows with gravity.

12. The system of claim 1, wherein the outflow of treated liquid is provided in response to an upflow of a portion of the first flow of liquid.

13. The system of claim 1, wherein the upflow of the portion of the first flow of liquid flows against gravity.
